(19) United States
(12) Patent Application Publication
(10) Pub. No.: US 2006/0245583 A1
(43) Pub. Date: Nov. 2, 2006

(54) Speech communication apparatus

(75) Inventors: Koichiro Mizushima, Kanagawa (JP); Minoru Matsui, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., KADOMA-SHI, OSAKA (JP)

(21) Appl. No.: 10/545,587

(22) PCT Filed: Jul. 1, 2004
(86) PCT No.: PCT/JP04/09697

§ 371 Date: Aug. 16, 2005

(30) Foreign Application Priority Data
Jul. 17, 2003 (JP) 2003-276181
Jun. 10, 2004 (JP) 2004-172528

(51) Int. Cl. H04M 9/08

(52) U.S. Cl. 379/406.01

(57) ABSTRACT

[PROBLEM]It is an object of the present invention to provide a voice communication apparatus which can prevent its echo suppressing characteristic from being deteriorated in response to the varied relative location of the microphone unit with respect to the speaker unit, and maintain the quality of the near-end signal to be transmitted to the far-end speaker.

[MEANS FOR SOLVING]Herein disclosed is a voice communication apparatus to be provided with a current value detecting unit 131 for detecting a current parameter value related to the relative location of either the first near-end voice converting unit 121 or the second near-end voice converting unit 122 with respect to the far-end signal converting unit 112, each of the first and second near-end signal delay sections 133 and 134 being operative to delay the near-end signal on the basis of the current parameter value detected by the current value detecting unit 131, and the first outputting section 135 being operative to output a signal indicative of the signal difference between the near-end signals respectively delayed by the first and second near-end signal delay sections 133 and 134.

### TECHNICAL FIELD OF THE INVENTION

The present invention relates to a voice communication apparatus, and more particularly to a voice communication apparatus for reliably suppressing an echo component of a near-end signal to be transmitted to a far-end speaker without being affected by a relative location of a microphone unit with respect to a speaker unit.

### DESCRIPTION OF THE RELATED ART

As one of conventional voice communication apparatuses, there is well known a voice communication apparatus which comprises a microphone unit for producing a near-end signal to be transmitted to a far-end speaker, and an adaptive filter for estimating an acoustic transfer characteristic between the microphone unit and a speaker unit. The conventional voice communication apparatus thus constructed is operative to suppress an echo component of the near-end signal on the basis of the estimated acoustic transfer characteristic.

The conventional voice communication apparatus is disclosed in, for example, Japanese Patent Laying-Open Publication No. 2000-244670, and shown in FIG. 25 as comprising first and second echo cancellers 52 and 53, and a voice signal switching unit 51 intervening between the first and second echo cancellers 52 and 53 to establish voice communication.

The first echo canceller 52 is operative to estimate a replica echo on the basis of a transfer function of a propagation path between the a speaker unit 54 and a microphone unit 55 to produce a replica echo signal indicative of the replica echo, while a subtracting unit 58 is operative to suppress the echo component of the near-end signal by subtracting the replica echo signal from the near-end signal outputted by the microphone unit 55.

When the conversion between two-lines and four-lines is performed in the conventional voice communication apparatus, the signal indicative of the near-end sound received by the microphone unit is received by the speaker unit. The second echo canceller 53 is operative to suppress an echo resulting from the fact that the signal indicative of the near-end sound is received by the speaker unit.

Here, the conventional voice communication apparatus of four-lines type may establish voice communication without the second echo canceller 53 and the voice signal switching unit 51.

Additionally, the coefficient of the transfer function of each of the first and second echo cancellers 52 and 53 is sequentially updated in response to the varied propagation path.

As another example, there is well known a conventional voice communication apparatus which comprises first and second microphone units each spaced apart from a speaker unit. The distance between the speaker unit and the first microphone unit is different from the distance between the speaker unit and the second microphone unit. The echo component of the signal outputted by one of the first and second microphone units is effectively suppressed on the basis of the signal outputted by the other of the first and second microphone units.

In the conventional voice communication apparatus disclosed in, for example, Japanese Patent Laying-Open Publication No. H08-223275, and shown in FIG. 26, each of the first and second microphone units 55 and 56 is operative to detect a sound outputted by the microphone.

In a learning step, the above mentioned voice communication apparatus is operative to update the echo suppressing characteristic of the echo canceller 57 electrically connected as a latter element to the first microphone unit 55 to minimize a power value of the signal difference between a signal outputted by the first microphone unit 55 and a signal outputted by the second microphone unit 56 on the basis of the transfer function of the propagation path between the speaker unit 54 and each of the first and second microphone units 55 and 56.

When the the above mentioned voice communication apparatus is utilized by its user, the above mentioned voice communication apparatus can suppress the echo component of the near-end signal even if the sound outputted by the speaker unit 54 is received by each of the first and second microphone units 55 and 56.

Each of the Japanese Patent Laying-Open Publications Nos. 2000-244670 and H08-223275 discloses an echo canceller having an echo suppressing characteristic to be determined on the basis of the propagation path between the speaker unit and the microphone unit.

If the conventional echo canceller disclosed in each of the Japanese Patent Laying-Open Publications Nos. 2000-244670 and H08-223275 is installed in a voice communication apparatus such as for example a mobile phone which comprises two housings connected to each other through a hinge, one of the housings accommodating a speaker unit, the other of the housings accommodating a microphone unit, the conventional echo canceller is required to update the echo suppressing characteristic in respose to the varied relative location of the microphone unit with respect to the speaker unit.

Each of the Japanese Patent Laying-Open Publications Nos. 2000-244670 and H08-223275, however, fails to disclose an echo canceller having an echo suppressing characteristic to be updated in response to the varied relative location of the microphone unit with respect to the speaker unit. If the conventional echo canceller disclosed in each of the Japanese Patent Laying-Open Publications Nos. 2000-244670 and H08-223275 is installed in a voice communication apparatus, the the conventional echo canceller cannot update the echo suppressing characteristic in response to the varied relative location of the microphone unit to the speaker unit. This leads to the fact that the quality of the near-end signal to be transmitted to the far-end speaker is deteriorated in response to the varied relative location of the microphone unit to the speaker unit.

It is, therefore, an object of the present invention to overcome the foregoing drawback, and to provide a voice communication apparatus which can maintain its echo suppressing characteristic to allow the near-end signal to be transmitted to the far-end speaker at a relatively high quality without being affected by the varied relative location of the microphone unit to the speaker unit.

### DISCLOSURE OF THE INVENTION

In accordance with one aspect of the present invention, there is provided a voice communication apparatus, comprising: a housing having a reference point; voice outputting means for outputting a far-end voice indicative of a far-end signal; voice inputting means for inputting a near-end voice; and echo suppressing means for suppressing an echo generated by the voice inputting means from the far-end voice outputted by the voice outputting means, wherein the voice outputting means includes a far-end signal converting unit spaced apart from the reference point with a predetermined first distance, and adapted to convert the far-end signal to the far-end voice, the voice inputting means includes a first near-end voice converting unit spaced apart from the reference point with a predetermined second distance, and adapted to convert the inputted near-end voice to a first near-end signal, and a second near-end voice converting unit disposed at a predetermined position in spaced relationship with the first near-end voice converting unit, and adapted to convert the inputted near-end voice to a second near-end signal, the echo suppressing means includes a current value detecting unit for detecting a current parameter value indicative of a current relative location of either the first near-end voice converting unit or the second near-end voice converting unit with respect to the far-end signal converting unit, a first propagation time calculating unit for calculating a first propagation time of the far-end voice converted by the far-end signal converting unit to a distance between the far-end signal converting unit and the first near-end voice converting unit on the basis of a first function to be provided with the parameter value defined as its independent variable and the first propagation time defined as its dependent variable, and a second propagation time of the far-end voice converted by the far-end signal converting unit to a distance between the far-end signal converting unit and the second near-end voice converting unit on the basis of a second function to be provided with the parameter value defined as its independent variable and the second propagation time defined as its dependent variable, and a first suppressed near-end signal outputting unit for outputting a first suppressed near-end signal after suppressing the echo on the basis of its echo suppressing characteristic updated in response to the first and second propagation time calculated by the first propagation time calculating unit.

The voice communication apparatus thus constructed as previously mentioned can reliably suppress the echo component of the near-end signal to be transmitted to the far-end speaker without being affected by the varied relative location of the microphone unit with respect to the speaker unit.

In the voice communication apparatus according to the present invention, the first suppressed near-end signal outputting unit may include a first near-end signal delay section for delaying the first near-end signal converted by the first near-end voice converting unit on the basis of the first propagation time calculated by the first propagation time calculating unit, a second near-end signal delay section for delaying the second near-end signal converted by the second near-end voice converting unit on the basis of the second propagation time calculated by the first propagation time calculating unit, and a first outputting section for outputting a signal indicative of the signal difference between the first near-end signal delayed by the first near-end signal delay section and the second near-end signal delayed by the second near-end signal delay section.

The voice communication apparatus thus constructed as previously mentioned can reliably suppress the echo component of the near-end signal to be transmitted to the far-end speaker by delaying the near-end signal on the basis of the propagation time of the far-end voice converted by the far-end signal converting unit to a distance between the far-end signal converting unit and either the first near-end voice converting unit or the second near-end voice converting unit.

In the voice communication apparatus according to the present invention, the echo suppressing means may include a first equalizing unit for equalizing a frequency spectrum of the first suppressed near-end signal outputted by the first suppressed near-end signal outputting unit with respect to the current parameter value detected by the current value detecting unit.

The voice communication apparatus thus constructed as previously mentioned can maintain the quality of the near-end signal to be transmitted to a far-end speaker even if the frequency spectrum of the suppressed near-end signal is deteriorated in response to the varied relative location of the near-end voice converting unit with respect to the far-end signal converting unit.

In the voice communication apparatus according to the present invention, the echo suppressing means may include a first near-end speaker's position detecting unit for detecting, as a first near-end speaker's position, a position of the near-end speaker with respect to either the first near-end voice converting unit or the second near-end voice converting unit on the basis of the cross-correlation function between the first near-end signal converted by the first near-end voice converting unit and the second near-end signal converted by the second near-end voice converting unit, and a second equalizing unit for equalizing a frequency spectrum of the first suppressed near-end signal outputted by the first suppressed near-end signal outputting unit with respect to the current parameter value detected by the current value detecting unit and the position of the near-end speaker detected by the first near-end speaker's position detecting unit.

The voice communication apparatus thus constructed as previously mentioned can maintain the quality of the near-end signal to be transmitted to a far-end speaker even if the relative location of the near-end speaker with respect to either the first near-end voice converting unit or the second near-end voice converting unit deviates from a predetermined reference position.

In the voice communication apparatus according to the present invention, the echo suppressing means may include a second near-end speaker's position detecting unit for detecting, as a second near-end speaker's position, a current position of the near-end speaker with respect to the far-end signal converting unit on the basis of the current parameter value detected by the current value detecting unit, and a third equalizing unit for equalizing a frequency spectrum of the first suppressed near-end signal outputted by the first suppressed near-end signal outputting unit with respect to the current parameter value detected by the current value detecting unit and the second near-end speaker's position detected by the second near-end speaker's position detecting unit.

The voice communication apparatus thus constructed as previously mentioned can maintain the quality of the near-end signal to be transmitted to a far-end speaker even if the relative location of the near-end speaker with respect to the far-end signal converting unit deviates from a predetermined reference position. The second near-end speaker's position detecting unit can be simple in construction in comparison with the first near-end speaker's position detecting unit.

In accordance with another aspect of the present invention, there is provided a voice communication apparatus, comprising: a housing having a reference point; voice outputting means for outputting a far-end voice indicative of a far-end signal; voice inputting means for inputting a near-end voice; and echo suppressing means for suppressing an echo generated by the voice inputting means from the far-end voice outputted by the voice outputting means, wherein the voice outputting means includes a far-end signal converting unit spaced apart from the reference point with a predetermined first distance, and adapted to convert the far-end signal to the far-end voice, the voice inputting means includes a first near-end voice converting unit spaced apart from the reference point with a predetermined second distance, and adapted to convert the inputted near-end voice to a first near-end signal, and a second near-end voice converting unit disposed at a predetermined position in spaced relationship with the first near-end voice converting unit, and adapted to convert the inputted near-end voice to a second near-end signal, the echo suppressing means includes a current value detecting unit for detecting a current parameter value indicative of a current relative location of either the first near-end voice converting unit or the second near-end voice converting unit with respect to the far-end signal converting unit, a second propagation time calculating unit for calculating a third propagation time of the near-end voice to be received by the first near-end voice converting unit with respect to the current parameter value detected by the current value detecting unit on the basis of a third function to be provided with the parameter value defined as its independent variable and the third propagation time defined as its dependent variable, and a fourth propagation time of the near-end voice to be received by the second near-end voice converting unit with respect to the current parameter value detected by the current value detecting unit on the basis of a fourth function to be provided with the parameter value defined as its independent variable and the fourth propagation time defined as its dependent variable, a remaining voice signal extracting unit for extracting a remaining voice signal on the basis of its remaining voice signal extracting characteristic updated in response to the third and fourth propagation time calculated by the second propagation time calculating unit, and a second suppressed near-end signal outputting unit for outputting a second suppressed near-end signal by subtracting the remaining voice signal extracted by the remaining voice signal extracting unit from either the first near-end signal converted by the first near-end voice converting unit or the second near-end signal converted by the second near-end voice converting unit.

The voice communication apparatus thus constructed as previously mentioned can reliably suppress the echo component and the background noise of the near-end signal to be transmitted to the far-end speaker without being affected by the varied relative location of the microphone unit with respect to the speaker unit.

In the voice communication apparatus according to the present invention, the remaining voice signal extracting unit may include a third near-end signal delay section for delaying the first near-end signal converted by the first near-end voice converting unit on the basis of the third propagation time calculated by the second propagation time calculating unit, a fourth near-end signal delay section for delaying the second near-end signal converted by the second near-end voice converting unit on the basis of the fourth propagation time calculated by the second propagation time calculating unit, and a remaining voice signal outputting section for outputting, as a remaining voice signal, a signal indicative of the signal difference between the first near-end signal delayed by the first near-end signal delay section and the second near-end signal delayed by the second near-end signal delay section. The second suppressed near-end signal outputting unit may include a disturbing sound signal estimating section for estimating a disturbing sound signal in either the first near-end signal converted by the first near-end voice converting unit or the second near-end signal converted by the second near-end voice converting unit on the basis of the remaining voice signal outputted by the remaining voice signal outputting section, a fifth near-end signal delay section for delaying either the first near-end signal converted by the first near-end voice converting unit or the second near-end signal converted by the second near-end voice converting unit with a delay time required to performing the estimation of the interfering near-end signal by the disturbing sound signal estimating section, a second outputting section for outputting a second suppressed near-end signal by subtracting the disturbing sound signal estimated by the disturbing sound signal estimating section from the near-end signal delayed, as a fifth delayed near-end signal, by the fifth near-end signal delay section, and an updating section for sequentially updating the disturbing sound signal estimating characteristic of the disturbing sound signal estimating section by performing the least squares estimation of the second suppressed near-end signal.

The voice communication apparatus thus constructed as previously mentioned can reliably suppress the echo component and the background noise of the near-end signal to be transmitted to the far-end speaker without being affected by the varied relative location of the near-end voice converting unit with respect to the far-end signal converting unit by reason that the remaining voice signal is extracted by the remaining voice signal extracting unit, and the disturbing sound signal is subtracted from the near-end signal.

In the voice communication apparatus according to the present invention, the echo suppressing means may further include an initial characteristic setting unit for setting an initial disturbing sound signal estimating characteristic of the updating section on the basis of the current parameter value detected by the current value detecting unit.

The voice communication apparatus thus constructed as previously mentioned can more reliably suppress the echo component and the background noise of the near-end signal to be transmitted to the far-end speaker by minimizing the second suppressed near-end signal on the basis of the least squares estimation to converge the disturbing sound signal estimating characteristic of the disturbing sound signal estimating section to the optimum disturbing sound signal estimating characteristic.

In the voice communication apparatus according to the present invention, the echo suppressing means may include a first near-end speaker's position detecting unit for detecting, as a first near-end speaker's position, a position of the near-end speaker with respect to either the first near-end voice converting unit or the second near-end voice converting unit on the basis of the cross-correlation function between the first near-end signal converted by the first near-end voice converting unit and the second near-end signal converted by the second near-end voice converting unit, and a second equalizing unit for equalizing a frequency spectrum of the first suppressed near-end signal outputted by the first suppressed near-end signal outputting unit with respect to the current parameter value detected by the current value detecting unit and the position of the near-end speaker detected by the first near-end speaker's position detecting unit.

The voice communication apparatus thus constructed as previously mentioned can maintain the quality of the near-end signal to be transmitted to a far-end speaker even if the relative location of the near-end speaker with respect to the far-end signal converting unit deviates from a predetermined reference position.

In the voice communication apparatus according to the present invention, the echo suppressing means may include a second near-end speaker's position detecting unit for detecting, as a second near-end speaker's position, a position of the near-end speaker with respect to the far-end signal converting unit on the basis of the current parameter value detected by the current value detecting unit, and a third equalizing unit for equalizing a frequency spectrum of the second suppressed near-end signal outputted by the second suppressed near-end signal outputting unit with respect to the current parameter value detected by the current value detecting unit and the second near-end speaker's position detected by the second near-end speaker's position detecting unit.

The voice communication apparatus thus constructed as previously mentioned can maintain the quality of the near-end signal to be transmitted to a far-end speaker by reason that the frequency spectrum of the near-end signal is equalized by the third equalizing unit even if the relative location of the near-end speaker with respect to the far-end signal converting unit deviates from a predetermined reference position. The second near-end speaker's position detecting unit can be simple in construction in comparison with the first near-end speaker's position detecting unit.

In accordance with further aspect of the present invention, there is provided a voice communication apparatus, comprising: a housing having a reference point; voice outputting means for outputting a far-end voice indicative of a far-end signal; voice inputting means for inputting a near-end voice; and echo suppressing means for suppressing an echo generated by the voice inputting means from the far-end voice outputted by the voice outputting means, wherein the voice outputting means includes a far-end signal converting unit spaced apart from the reference point with a predetermined first distance, and adapted to convert the far-end signal to the far-end voice, the voice inputting means includes a first near-end voice converting unit spaced apart from the reference point with a predetermined second distance, and adapted to convert the inputted near-end voice to a first near-end signal, and a second near-end voice converting unit disposed at a predetermined position in spaced relationship with the first near-end voice converting unit, and adapted to convert the inputted near-end voice to a second near-end signal, the echo suppressing means includes an echo component detecting unit for detecting, as an echo component signal, a component other than a real near-end voice to be specified as a cross-component in each of the first and second near-end signals on the basis of the first and second near-end signals respectively converted by the first and second near-end voice converting units, and a third suppressed near-end signal outputting unit for outputting a third suppressed near-end signal by subtracting the echo component signal detected by the echo component detecting unit from either the first near-end signal converted by the first near-end voice converting unit or the second near-end signal converted by the second near-end voice converting unit.

Here, the term “echo component signal” is intended to indicate a disturbing component of the near-end signal other than the near-end voice component of the near-end signal. The disturbing component of the near-end voice includes not only an echo but also a background noise.

The voice communication apparatus thus constructed as previously mentioned can maintain the quality of the near-end signal to be transmitted to a far-end speaker by reliably suppressing the echo component and the background noise of the near-end signal to be transmitted to the far-end speaker without being affected by the varied relative location of the near-end voice converting unit with respect to the far-end signal converting unit by reason that the echo component signal is subtracted from the near-end signal by the third suppressed near-end signal outputting unit.

In the voice communication apparatus according to the present invention, the echo component detecting unit may include a real near-end voice estimating section for estimating, as a real near-end signal, a real near-end voice to be specified as a cross-component in each of the first and second near-end signals respectively converted by the first and second near-end voice converting units, a sixth near-end signal delay section for delaying either the first near-end signal converted by the first near-end voice converting unit or the second near-end signal converted by the second near-end voice converting unit with a delay time required to performing the estimation of the real near-end signal by the real near-end voice estimating section, and an echo component signal outputting section for outputting, as a first echo component signal, a signal indicative of the signal difference between the near-end signal delayed as a sixth delayed near-end signal by the sixth near-end signal delay section and the real near-end signal estimated by the real near-end voice estimating section. The third suppressed near-end signal outputting unit may include an echo component estimating section for estimating, as a second echo component signal, a signal to be specified as a component other than the real near-end voice in either the first near-end signal converted by the first near-end voice converting unit or the second near-end signal converted by the second near-end voice converting unit on the basis of the echo component signal outputted by the echo component signal outputting section, a seventh near-end signal delay section for delaying either the first near-end signal converted by the first near-end voice converting unit or the second near-end signal converted by the second near-end voice converting unit with a delay time required to performing the estimation of the echo component signal by the echo component estimating section, and a third outputting section for outputting a third suppressed near-end signal by subtracting the second echo component signal estimated by the echo component estimating section from the near-end signal delayed as a seventh delayed near-end signal by the seventh near-end signal delay section.

The voice communication apparatus thus constructed as previously mentioned can maintain the quality of the near-end signal to be transmitted to a far-end speaker by reliably suppressing the echo component and the background noise of the near-end signal to be transmitted to the far-end speaker without being affected by the varied relative location of the near-end voice converting unit with respect to the far-end signal converting unit by reason that the echo component signal is estimated by the echo component estimating section, and the echo component signal is subtracted from the near-end signal.

In the voice communication apparatus according to the present invention, the real near-end voice estimating section may have a first adaptive filter for executing the adaptive signal processing to perform the least absolute deviation estimation of a signal outputted by the echo component signal outputting section to either the first near-end signal converted by the first near-end voice converting unit or the second near-end signal converted by the second near-end voice converting unit. The echo component estimating section may have a second adaptive filter for executing the adaptive signal processing to perform the least absolute deviation estimation of a signal outputted by the third outputting section to the echo component signal outputted by the echo component signal outputting section. The echo suppressing means may include a current value detecting unit for detecting a current parameter value indicative of a current relative location of either the first near-end voice converting unit or the second near-end voice converting unit with respect to the far-end signal converting unit, a first initial value determining unit for determining, as a parameter of the adaptive signal processing, initial filter coefficient of the first adaptive filter in response to the current parameter value detected by the current value detecting unit, and a second initial value determining unit for determining, as a parameter of the adaptive signal processing, initial filter coefficient of the second adaptive filter in response to the current parameter value detected by the current value detecting unit.

The voice communication apparatus thus constructed as previously mentioned can maintain the quality of the near-end signal to be transmitted to a far-end speaker by reliably and immediately suppressing the echo component and the background noise of the near-end signal to be transmitted to the far-end speaker without being affected by the varied relative location of the near-end voice converting unit with respect to the far-end signal converting unit by reason that the initial filter coefficient of the first adaptive filter is determined by the first initial value determining unit in response to the current parameter value detected by the current value detecting unit, and the initial filter coefficient of the second adaptive filter is determined by the second initial value determining unit in response to the current parameter value detected by the current value detecting unit.

In the voice communication apparatus according to the present invention, the echo suppressing means may include an adaptive controlling unit for issuing an instruction to the first adaptive filter to update the first filter coefficient when the judgment is made that the near-end signal predetermined as one of the first and second near-end signals exceeds in amplitude the far-end signal, and issuing an instruction to the second adaptive filter to update the second filter coefficient when the judgment is made that the far-end signal exceeds in amplitude one of the first and second near-end signals.

The voice communication apparatus thus constructed as previously mentioned can maintain the quality of the near-end signal to be transmitted to a far-end speaker by reliably and immediately suppressing the echo component and the background noise of the near-end signal to be transmitted to the far-end speaker without being affected by the varied relative location of the near-end voice converting unit with respect to the far-end signal converting unit by reason that the adaptive controlling unit is operative to issue each of the instruction to the first adaptive filter to update the first filter coefficient and the instruction to the second adaptive filter to update the second filter coefficient on the basis of the near-end signal and the far-end signal.

### BRIEF DESCRIPTION OF THE DRAWINGS

The features and advantages of a voice communication apparatus according to the present invention will be more clearly understood from the following description taken in conjunction with the accompanying drawings:

FIG. 1 is a block diagram showing a functional constitution of the first embodiment of the voice communication apparatus according to the present invention;

FIG. 2 is a block diagram showing a hardware constitution of the first embodiment of the voice communication apparatus according to the present invention;

FIG. 3 is a schematic view showing a mobile phone exemplified as the voice communication apparatus according to the present invention;

FIG. 4 is a flow chart showing an operation of the first embodiment of the voice communication apparatus according to the present invention;

FIG. 5 is a block diagram showing a functional constitution of the first embodiment of the voice communication apparatus in which the echo suppressing means further includes a first equalizing unit;

FIG. 6 is a flowchart showing an operation of the first embodiment of the voice communication apparatus in which the echo suppressing means further includes a first equalizing unit;

FIG. 7 is a flowchart showing an operation of the first equalizing unit of the voice communication apparatus according to the first embodiment of the present invention;

FIG. 8 is a graph showing an equalization characteristic of the first equalizing unit of the voice communication apparatus according to the first embodiment of the present invention;

FIG. 9 is a block diagram showing a functional constitution of the first embodiment of the voice communication apparatus in which the echo suppressing means further includes a second equalizing unit;

FIG. 10 is a flowchart showing an operation of the first embodiment of the voice communication apparatus in which the echo suppressing means further includes a second equalizing unit;

FIG. 11 is a flowchart showing an operation of the second equalizing unit of the voice communication apparatus according to the first embodiment of the present invention;

FIG. 12 is a block diagram showing a functional constitution of the first embodiment of the voice communication apparatus in which the echo suppressing means further includes a third equalizing unit;

FIG. 13 is a graph showing an equalization characteristic of the second equalizing unit of the voice communication apparatus according to the first embodiment of the present invention;

FIG. 14 is a block diagram showing a functional constitution of the second embodiment of the voice communication apparatus according to the present invention;

FIG. 15 is a flow chart showing an operation of the second embodiment of the voice communication apparatus according to the present invention;

FIG. 16 is a flowchart showing an operation of the echo suppressing means of the voice communication apparatus according to the second embodiment of the present invention;

FIG. 17 is a block diagram showing a functional constitution of the second embodiment of the voice communication apparatus in which the echo suppressing means further includes an initial characteristic setting unit;

FIG. 18 is a flowchart showing an operation of the second embodiment of the voice communication apparatus in which the echo suppressing means further includes an initial characteristic setting unit;

FIG. 19 is a block diagram showing a functional constitution of the second embodiment of the voice communication apparatus in which the echo suppressing means further includes a second equalizing unit;

FIG. 20 is a flowchart showing an operation of the second embodiment of the voice communication apparatus in which the echo suppressing means further includes a second equalizing unit;

FIG. 21 is a block diagram showing a functional constitution of the second embodiment of the voice communication apparatus in which the echo suppressing means further includes a third equalizing unit;

FIG. 22 is a block diagram showing a functional constitution of the third embodiment of the voice communication apparatus according to the present invention;

FIG. 23 is a flow chart showing an operation of the third embodiment of the voice communication apparatus according to the present invention;

FIG. 24 is a graphs showing, as an example of the near-end signal to be transmitted to the far-end speaker, the signal outputted with no echo suppression, the signal outputted by conventional apparatus and the signal outputted by the voice communication apparatus according to the present invention;

FIG. 25 is a block diagram showing a conventional voice communication apparatus; and

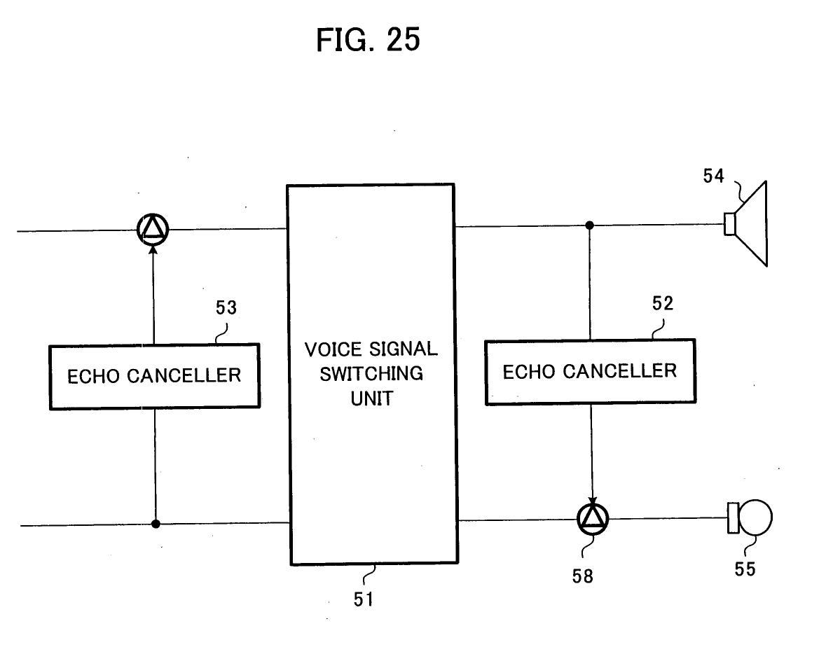

FIG. 26 is a block diagram showing a conventional voice communication apparatus.

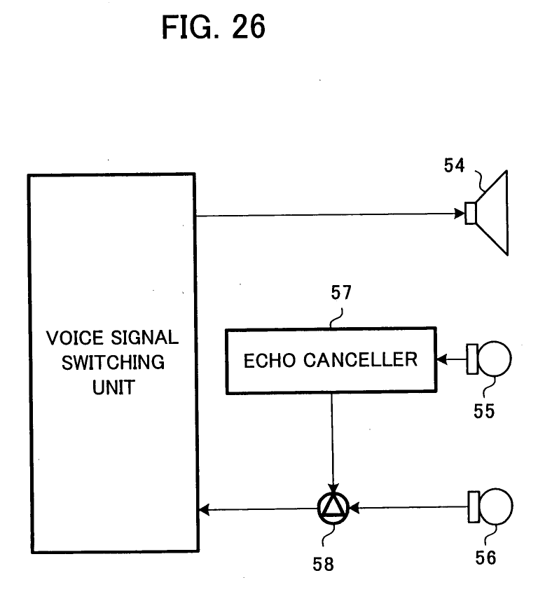

### DESCRIPTION OF THE PREFERRED EMBODIMENTS

The embodiments of the voice communication apparatus will be described hereinafter in accordance with accompanying drawings.

### First Embodiment

In this specification, the term “reference point” is intended to indicate a point required to define a current relative location of either a first near-end voice converting unit or a second near-end voice converting unit with respect to a far-end signal converting unit. In a mobile phone to be exemplified as the voice communication apparatus according to the present invention, the mobile phone comprises a housing including complementary sections, and a hinge having a reference point. The hinge intervenes the complementary sections to allow the complementary sections to be angularly moved with respect to each other.

In this specification, the term “reference position” is intended to indicate a position of a near-end speaker with respect to the far-end signal converting unit or either a first near-end voice converting unit or a second near-end voice converting unit. The reference position is determined in design stage. The location of the near-end speaker with respect to either the first near-end voice converting unit or the second near-end voice converting unit is defined as a first reference position. The location of the near-end speaker with respect to the far-end signal converting unit is defined as a second reference position.

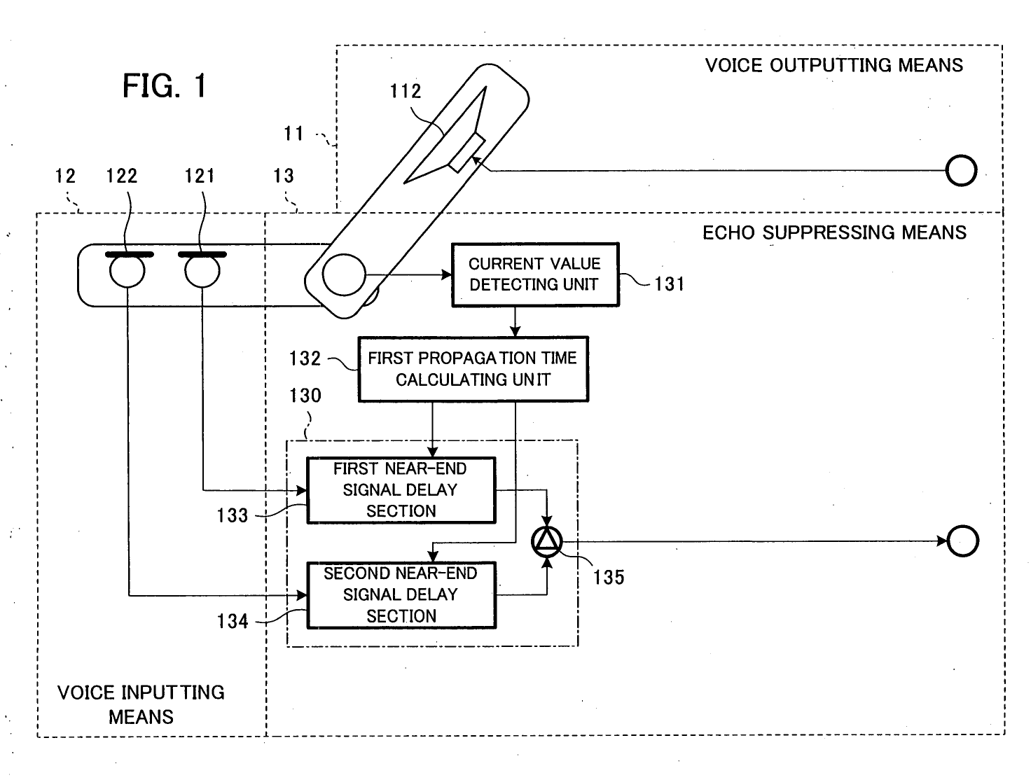

The constitution of the first embodiment of the voice communication apparatus according to the present invention will be firstly described hereinafter with reference to FIG. 1.

As shown in FIG. 1, the voice communication apparatus comprises voice outputting means 11 for outputting a far-end voice indicative of a far-end signal, voice inputting means 12 for inputting a near-end voice, and echo suppressing means 13 for suppressing an echo generated by the voice inputting means 12 from the far-end voice outputted by the voice outputting means 11.

The voice outputting means 11 includes a far-end signal converting unit 112 spaced apart from the reference point with a predetermined first distance, and adapted to convert the far-end signal to the far-end voice.

The voice inputting means 12 includes a first near-end voice converting unit 121 spaced apart from the reference point with a predetermined second distance, and adapted to convert the inputted near-end voice to a first near-end signal, and a second near-end voice converting unit 122 disposed at a predetermined position in spaced relationship with the first near-end voice converting unit 121, and adapted to convert the inputted near-end voice to a second near-end signal.

The echo suppressing means 13 includes a current value detecting unit 131 for detecting a current parameter value related to a current relative location of either the first near-end voice converting unit 121 or the second near-end voice converting unit 122 with respect to the far-end signal converting unit 112, a first propagation time calculating unit 132 for calculating a propagation time (hereinafter referred to as “first propagation time”) of the far-end voice converted by the far-end signal converting unit 112 to a distance between the far-end signal converting unit 112 and the first near-end voice converting unit 121 on the basis of a first function to be provided with the parameter value defined as its independent variable and the first propagation time defined as its dependent variable, and a propagation time (hereinafter referred to as “second propagation time”) of the far-end voice converted by the far-end signal converting unit 112 to a distance between the far-end signal converting unit 112 and the second near-end voice converting unit 122 on the basis of a second function to be provided with the parameter value defined as its independent variable and the second propagation time defined as its dependent variable, and a first suppressed near-end signal outputting unit 130 for outputting a first suppressed near-end signal after suppressing the echo on the basis of its echo suppressing characteristic updated in response to the first and second propagation time calculated by the first propagation time calculating unit 132.

The first suppressed near-end signal outputting unit 130 includes a first near-end signal delay section 133 for delaying the first near-end signal converted by the first near-end voice converting unit 121 on the basis of the first propagation time calculated by the first propagation time calculating unit 132, a second near-end signal delay section 134 for delaying the second near-end signal converted by the second near-end voice converting unit 122 on the basis of the second propagation time calculated by the first propagation time calculating unit 132, and a first outputting section 135 for outputting a signal indicative of the signal difference between the first near-end signal delayed by the first near-end signal delay section 133 and the second near-end signal delayed by the second near-end signal delay section 134.

As shown in FIG. 1, the first suppressed near-end signal outputting unit 130 includes a first near-end signal delay section 133 and a second near-end signal delay section 134 in the voice communication apparatus according to the first embodiment of the present invention. However, the first near-end signal delay section 133 may be omitted in the voice communication apparatus according to the first embodiment of the present invention if the first propagation time is negligible small. The second near-end signal delay section 134, on the other hand, may be omitted in the voice communication apparatus according to the first embodiment of the present invention if the second propagation time is negligible small.

With the second near-end signal delay section 134 omitted in the voice communication apparatus according to the first embodiment of the present invention, the first outputting section 135 may be operative to output a signal indicative of the signal difference between the first near-end signal delayed by the first near-end signal delay section 133 and the second near-end signal converted by the second near-end voice converting unit 122.

If, on the other hand, the first suppressed near-end signal outputting unit 130 includes a first near-end signal delay section 133 and a second near-end signal delay section 134 in the voice communication apparatus according to the first embodiment of the present invention, the first outputting section 135 is operative to output the signal indicative of the signal difference between the first near-end signal delayed by the first near-end signal delay section 133 and the second near-end signal delayed by the second near-end signal delay section 134 if, for example, the first and second near-end signal delay sections 133 and 134 are omitted in the voice communication apparatus according to first embodiment of the present invention.

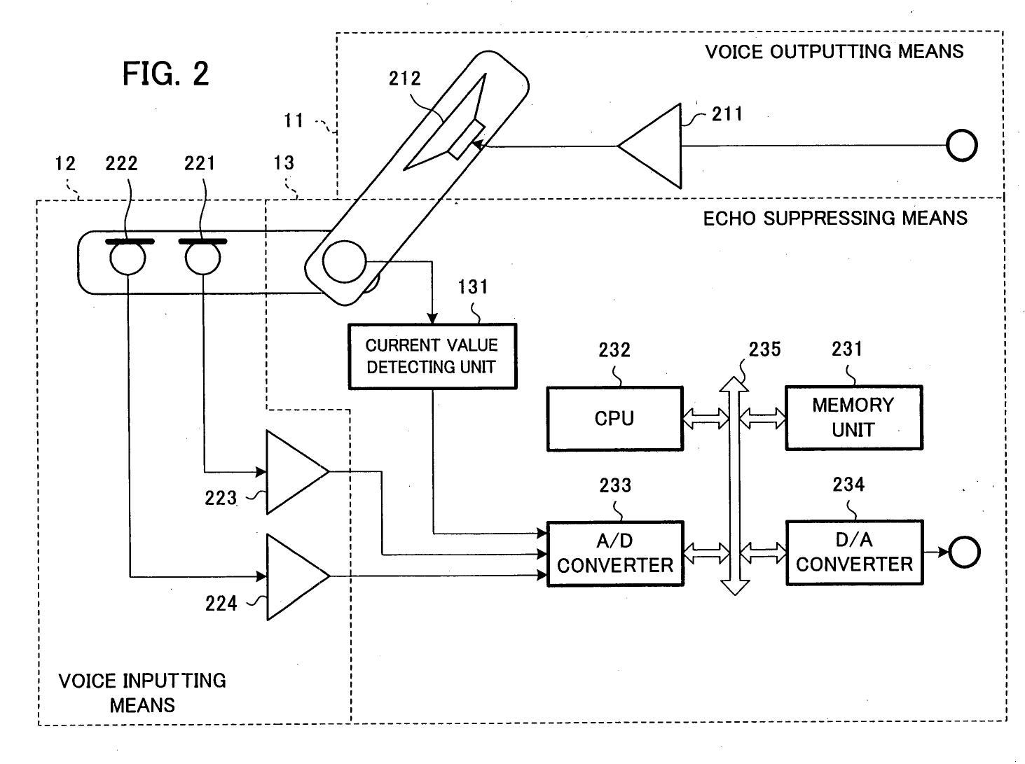

The hardware constitution of the first embodiment of the voice communication apparatus according to the present invention will be described hereinafter with reference to FIG. 2.

As shown in FIG. 2, the far-end signal converting unit 112 of the voice outputting means 11 is constituted by a far-end signal amplifier 211 and a speaker unit 212. The first microphone unit 221 and the first near-end signal amplifier 223 collectively constitute a first near-end voice converting unit 121 of the voice inputting means 12. The second microphone unit 222 and the second near-end signal amplifier 224 collectively constitute a second near-end voice converting unit 122 of the voice inputting means 12.

The current value detecting unit 131 of the echo suppressing means 13 may be constituted by a detector such as for example a rotary encoder and a potentiometer. The detector is operative to detect a current parameter value related to the current relative location of either the first near-end voice converting unit 121 or the second near-end voice converting unit 122 with respect to the far-end signal converting unit 112 to convert the parameter value to an electric signal. Here, the current parameter value related to the current relative location of either the first near-end voice converting unit 121 or the second near-end voice converting unit 122 with respect to the far-end signal converting unit 112 may be detected in a discontinuous manner by the detector. For example, the detector may be replaced by a switching element for selectively switching its own open and closed states by detecting whether or not the relative location of either the first near-end voice converting unit 121 or the second near-end voice converting unit 122 with respect to the far-end signal converting unit 112 is equal to at least one specific position.

On the other hand, the constitutional elements of the echo suppressing means 13 collectively are constituted by a central processing unit (CPU) 232 except for the current value detecting unit 131. The central processing unit (CPU) 232 is operative to execute an echo-suppressing program stored in a memory unit 231.

The echo suppressing means 13 further includes an analogue-to-digital converter 233 (hereinafter simply referred to as “A/D converter”) for converting each of the near-end signals respectively outputted by the first and second near-end signal amplifiers 223 and 224 and the parameter value to a digital signal and a digital-to-analogue converter 234 (hereinafter simply referred to as “D/A converter”) for converting the suppressed near-end signal to an analogue signal. The memory unit 231, the CPU 232, the A/D converter 233 and the D/A converter 234 are electrically connected to one another through a bus line 235. Here, if the current value detecting unit 131 is constituted by the switching element, the echo suppressing means 13 may further include a digital input interface unit have inputted therein the current parameter value to be received by the CPU 232.

The hardware construction of each of the second and third embodiments of the voice communication apparatus is substantially the same as that of first embodiment of the voice communication apparatus. Therefore, the hardware construction of each of the second and third embodiments of the voice communication apparatus will not be described hereinafter.

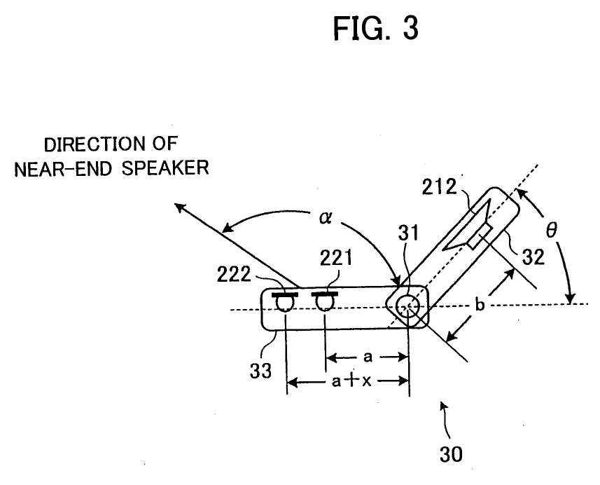

The following description will be then directed to the first and second functions of the first propagation time calculating unit 132 of the echo suppressing means 13 of the mobile phone 30 which is shown in FIG. 3 as one embodiment of the voice communication apparatus according to the present invention. The current parameter value detected by the current value detecting unit 131 is defined as its independent variable in each of the first and second functions. Each of the first propagation time of the far-end voice converted by the far-end signal converting unit 112 to the distance between the far-end signal converting unit 112 and the first near-end voice converting unit 121 and the second propagation time of the far-end voice converted by the far-end signal converting unit 112 to the distance between the far-end signal converting unit 112 and the second near-end voice converting unit 122 is defined as its dependent variable in each of the first and second functions.

The mobile phone 30 comprises a housing having first and second complementary sections 32 and 33 and a hinge 31 having a reference point. The hinge 31 intervenes between the first complementary section 32 and the second complementary section 33 as a reference point to allow the first and second complementary sections 32 and 33 to be angularly movable with respect to each other. The first complementary section 32 accommodates the speaker unit 212 of the far-end signal converting unit 112, while the second complementary section 33 accommodates the first and second microphone units 221 and 222 of the first and second near-end voice converting units 121 and 122.

Each of the distance “a” between the hinge 31 and the first microphone unit 221, the distance “(a+x)” between the hinge 31 and the second microphone unit 222, and the distance “b” between the hinge 31 and the speaker unit 212 is substantially invariable under the condition that the first and second complimentary sections 32 and 33 are angularly moved with respect to each other.

The angle (see FIG. 3) “θ” of the first complementary section 32 to the second complementary section 33 is required, as a parameter related to the relative location of either the first microphone unit 221 or the second microphone unit 222 with respect to the speaker unit 212, for the CPU 232 to calculate the distance between the far-end signal converting unit 112 and either the first near-end voice converting unit 121 or the second near-end voice converting unit 122.

The propagation time “T1” of the far-end voice to the distance between the far-end signal converting unit 112 and the first near-end voice converting unit 121 is defined as a function of the angle “θ”, and represented by the following equation (1). The propagation time “T2” of the far-end voice to the distance between the far-end signal converting unit 112 and the second near-end voice converting unit 122 is defined as a function of the angle “θ”, and represented by the following equation (2).
T₁=\sqrt{a²+b²⁺²ab·cos θ}/v (1)
T₁=\sqrt{a²+b²+2ab·cos θ+2x(b·cos θ+a)+x²}/v (2)
wherein the legend “v” is a voice speed.

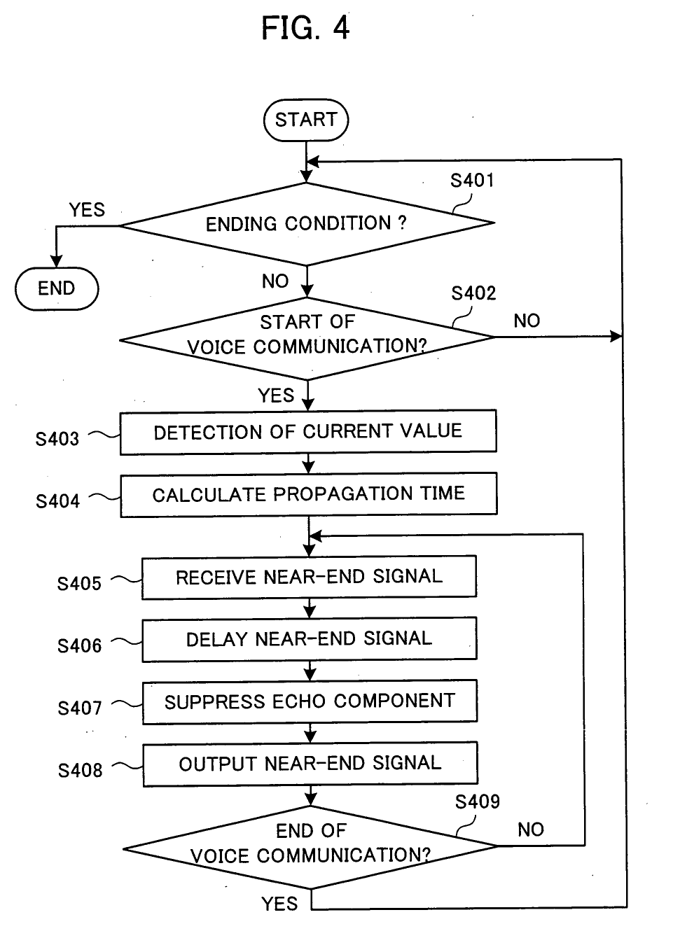

The operation of the echo suppressing means 13 of the voice communication apparatus according to first embodiment of the present invention will be described hereinafter with reference to FIG. 4.

The judgment is firstly made by the echo suppressing means 13 on whether or not voice communication ending conditions are fulfilled in the voice communication apparatus, for example, on whether or not the voice communication apparatus is in an on-hook state (in step S401). When the judgment is made in the step S401 that the voice communication ending conditions are fulfilled in the voice communication apparatus, the echo suppressing means 13 is operated to stop the operation of suppressing the echo component of the near-end signal. When, on the other hand, judgment is made in the step S401 that the voice communication ending conditions are not fulfilled in the voice communication apparatus, the judgment is made on whether or not the voice communication is started between the far-end speaker and the near-end speaker on the basis of the signal level of the near-end signal (in step S402).

When the judgment is made in the step S402 that the voice communication is not started between the far-end speaker and the near-end speaker, the step S402 proceeds to the step S401. When, on the other hand, the judgment is made in the step S402 that the voice communication is started between the far-end speaker and the near-end speaker, the current parameter value related to the current relative location of either the first near-end voice converting unit 121 or the second near-end voice converting unit 122 with respect to the far-end signal converting unit 112 is detected by the current value detecting unit 131. The current parameter value is then received from the current value detecting unit 131 through the A/D converter 233 by the CPU 232 (in step S403).

The current parameter value received from the current value detecting unit 131 through the A/D converter 233 is then substituted for the independent variable of each of the first and second functions, the first function being provided with the first propagation time of the far-end voice converted by the far-end signal converting unit 112 to the distance between the far-end signal converting unit 112 and the first near-end voice converting unit 121 defined as its dependent variable and the current parameter value defined as its independent variable, and the second function being provided with the second propagation time of the far-end voice converted by the far-end signal converting unit 112 to the distance between the far-end signal converting unit 112 and the second near-end voice converting unit 122 defined as its dependent variable and the current parameter value defined as its independent variable (in step S404). The operation in the step S404 is performed by the first propagation time calculating unit 132.

The first near-end signal is received from the first near-end voice converting unit 121 through the A/D converter 233 by the CPU 232, while the second near-end signal received from the second near-end voice converting unit 122 through the A/D converter 233 by the CPU 232 (in step S405). The first near-end signal is delayed by the first near-end signal delay section 133 on the basis of the first propagation time calculated by the first propagation time calculating unit 132, while the second near-end signal is delayed by the second near-end signal delay section 134 on the basis of the second propagation time calculated by the first propagation time calculating unit 132 (in step S406).

As a method of delaying the near-end signal, the near-end signal may be delayed by a shift register with the delay time approximated by an integral multiple of a sampling rate of the near-end signal. If the above mentioned delay section is constituted by a finite impulse response (FIR) filter, the near-end signal can be more accurately delayed by the FIR filter in comparison with the shift register.

Here, the operation in the step S406 is performed by each of the first and second near-end signal delay sections 133 and 134.

The echo component of the near-end signal is suppressed as a result of the fact that by calculating the signal difference between first near-end signal delayed by the first near-end signal delay section 133 and the second near-end signal delayed by the second near-end signal delay section 134 (in step S407). Here, the operation in the step S407 is performed by each of the first and second near-end signal delay sections 133 and 134.

Here, the operation in the steps S406 and S408 is performed by the first outputting section 135.

The first suppressed near-end signal is then converted to an analogue signal, and outputted by the D/A converter 234 (in step S408).

The judgment is made (in step S409) on whether or not the voice communication is completed between the far-end speaker and the near-end speaker by judging whether or not, for example, the near-end signal is equal to or smaller in signal level than a predetermined threshold level. When the judgment is made in the step S409 that the near-end signal is larger in signal level than the predetermined threshold level, and that the voice communication is not completed between the far-end speaker and the near-end speaker, the step S409 proceed to the step S405. When, on the other hand, the judgment is made in the step S409 that the near-end signal is small in signal level than the predetermined threshold level, and that the voice communication is completed between the far-end speaker and the near-end speaker, the judgment is made (in step S401) on whether or not to fulfill a voice communication ending condition, for example, the voice communication apparatus is in an on-hook state.

In the above mentioned process, the first propagation time calculated by the first propagation time calculating unit 132 is set in advance as a delay time in the first near-end signal delay section 133, while the second propagation time calculated by the first propagation time calculating unit 132 is set in advance as a delay time in the second near-end signal delay section 134.

From a practical standpoint, it is preferable that the propagation time of the far-end voice converted by the far-end signal converting unit 112 to the distance between the far-end signal converting unit 112 and one of the first and second near-end voice converting units 121 and 122 is set in advance as a fixed delay time in one of the first and second near-end signal delay sections 133 and 134, while the propagation time of the far-end voice converted by the far-end signal converting unit 112 to the distance between the far-end signal converting unit 112 and the other of the first and second near-end voice converting units 121 and 122 is set in advance as a variable delay time in the other of the first and second near-end signal delay sections 133 and 134.

If the relative location of either the first near-end voice converting unit 121 or the second near-end voice converting unit 122 with respect to the far-end signal converting unit 112 can be specified by the voice communication apparatus, it is easy to update the variable delay time set in advance in response to the varied relative location of either the first near-end voice converting unit 121 or the second near-end voice converting unit 122 with respect to the far-end signal converting unit 112. If the variable delay time is smaller than the fixed delay time, in other words, the variable delay time is a negative, it is easy to update both the fixed delay time and the variable delay time.

From the above detail description, it will be understood that the first embodiment of the voice communication apparatus according to the present invention can reliably suppress the echo component of the near-end signal to be transmitted to the far-end speaker without being affected by the varied relative location of either the first near-end voice converting unit 121 or the second near-end voice converting unit 122 with respect to the far-end signal converting unit 112 by reason that the echo suppressing means 13 of the voice communication apparatus comprises a current value detecting unit 131, a first propagation time calculating unit 132, a first near-end signal delay section 133, a second near-end signal delay section 134 and a first outputting section 135.

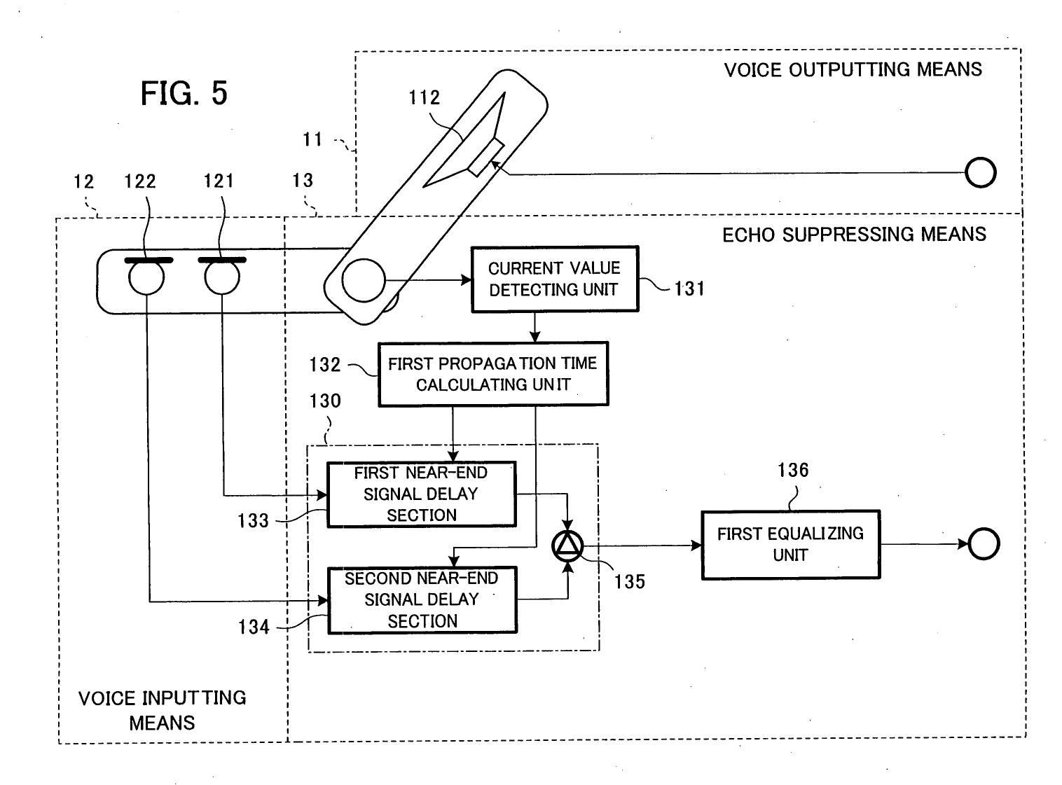

As shown in FIG. 5, the echo suppressing means 13 of the voice communication apparatus according to the first embodiment of the present invention may further include a first equalizing unit 136, as an element electrically connected to the output side of the first suppressed near-end signal outputting unit 130, for equalizing a frequency spectrum of the first suppressed near-end signal outputted by the first suppressed near-end signal outputting unit 130 on the basis of the current parameter value detected by the current value detecting unit 131.

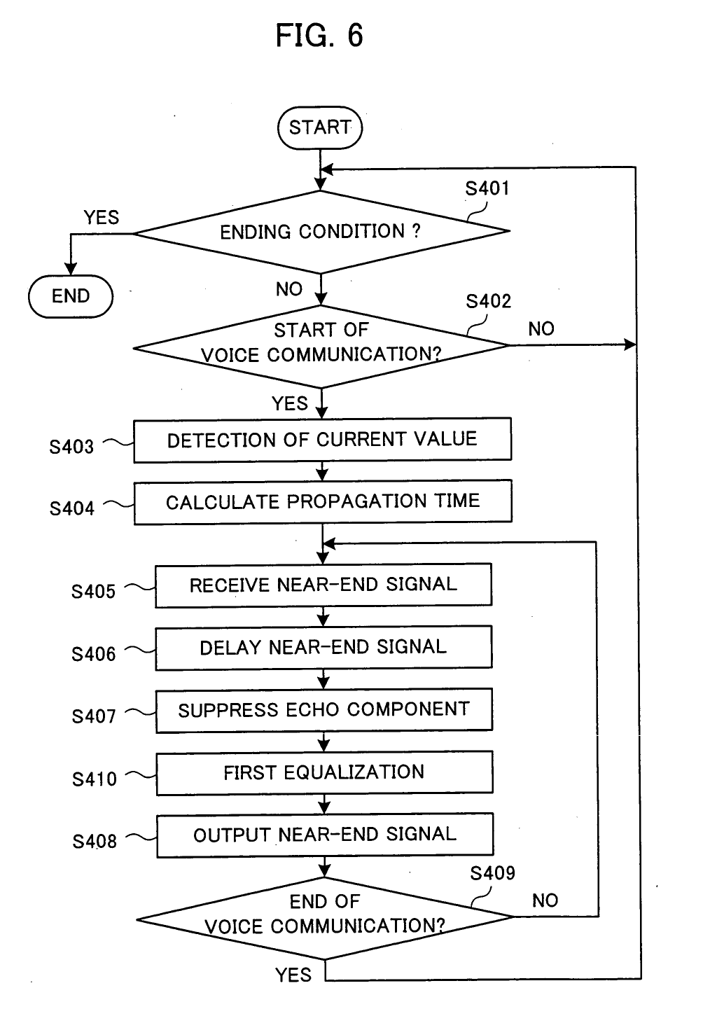

The operation of the voice communication apparatus shown in the flowchart of FIG. 6 is the same as the operation of the voice communication apparatus shown in the flowchart of FIG. 4 with the exception of the operation (in step S410) of the first equalizing unit 136 for equalizing the frequency spectrum of the suppressed near-end signal.

In this case, the operation of the first equalizing unit 136 is realized by having the CPU 232 execute a program stored in the memory unit 231.

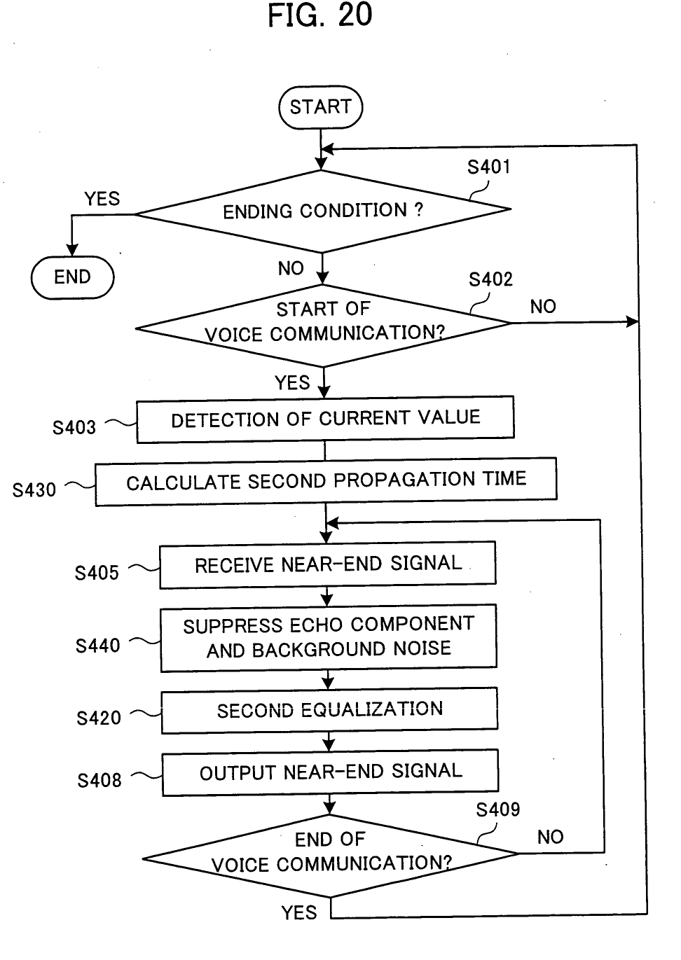

The operation to be performed in the steps S401 to S440, S408 and S409 shown in FIG. 20 are substantially the same as the operation to be performed in the steps S401 to S440, S408 and S409 shown in FIG. 4. Therefore, the steps S401 to S440, S408 and S409 shown in FIG. 20 will be described hereinafter.

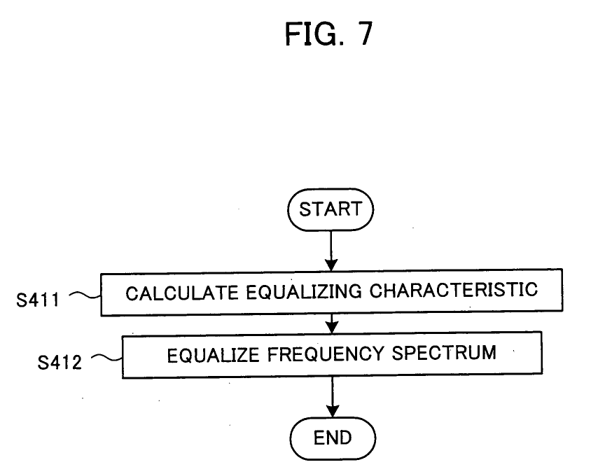

The operation of the first equalizing unit 136 will be then described thereinafter with reference to the flowchart of FIG. 7.

The echo component of the near-end signal is firstly suppressed (in step S407). The equalization characteristic is then calculated from the equalization characteristic stored in advance in the memory unit 231 on the basis of the current parameter value detected by the current value detecting unit 131 (in step S411). The frequency spectrum of the near-end signal is equalized (in step S412). The above mentioned operation is performed by the first equalizing unit 136.

The following description will be directed to the first equalizing unit 136 under the condition that the voice communication apparatus according to the present invention is constituted by a mobile phone which comprises a housing having two complementary sections.

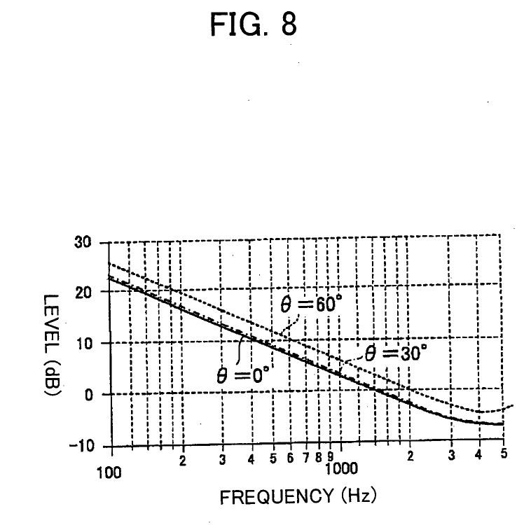

FIG. 8 is a graph showing the relationship between the signal level of the suppressed near-end signal and the frequency of the suppressed near-end signal under the condition that the near-end speaker occupies the second reference point spaced apart from the far-end signal converting unit 112, and the angle of one of the complementary sections 32 and 33 to the other of the complementary sections 32 and 33 is equal to the angle of each of 0 degree, 30 degrees and 60 degrees. The data on the suppressed near-end signal shown in FIG. 8 is stored in advance in the memory unit 231.

When, for example, the judgment is made that the angle of one of the complementary sections 32 and 33 to the other of the complementary sections 32 and 33 is equal to the angle of 30 degrees on the basis of the current value detected by the current value detecting unit 131, one equalization characteristic indicated by the alternative long and short dash line in FIG. 8 is selected from among the equalization characteristics stored in the memory unit 231.

If the judgment is made that the angle of one of the complementary sections 32 and 33 to the other of the complementary sections 32 and 33 the is equal to the angle of 45 degrees on the basis of the current value detected by the current value detecting unit 131, the equalization characteristic corresponding to the angle of 45 degrees is calculated from the selected equalization characteristic on the basis of an interpolation method or other method by reason that the equalization characteristic corresponding to the angle of 45 degrees is not stored in advance in the memory unit 231.

From the above detail description, it will be understood that the voice communication apparatus can maintain the quality of the near-end voice signal to be transmitted to the far-end speaker by preventing the frequency spectrum of the suppressed near-end signal from being deteriorated in response to the varied relative location of the voice inputting means 12 with respect to the voice outputting means 11 by reason that the echo suppressing means 13 further includes a first equalizing unit 136, as an element electrically connected to the output side of the first suppressed near-end signal outputting unit 130, for equalizing a frequency spectrum of the first suppressed near-end signal on the basis of the current parameter value detected by the current value detecting unit 131.

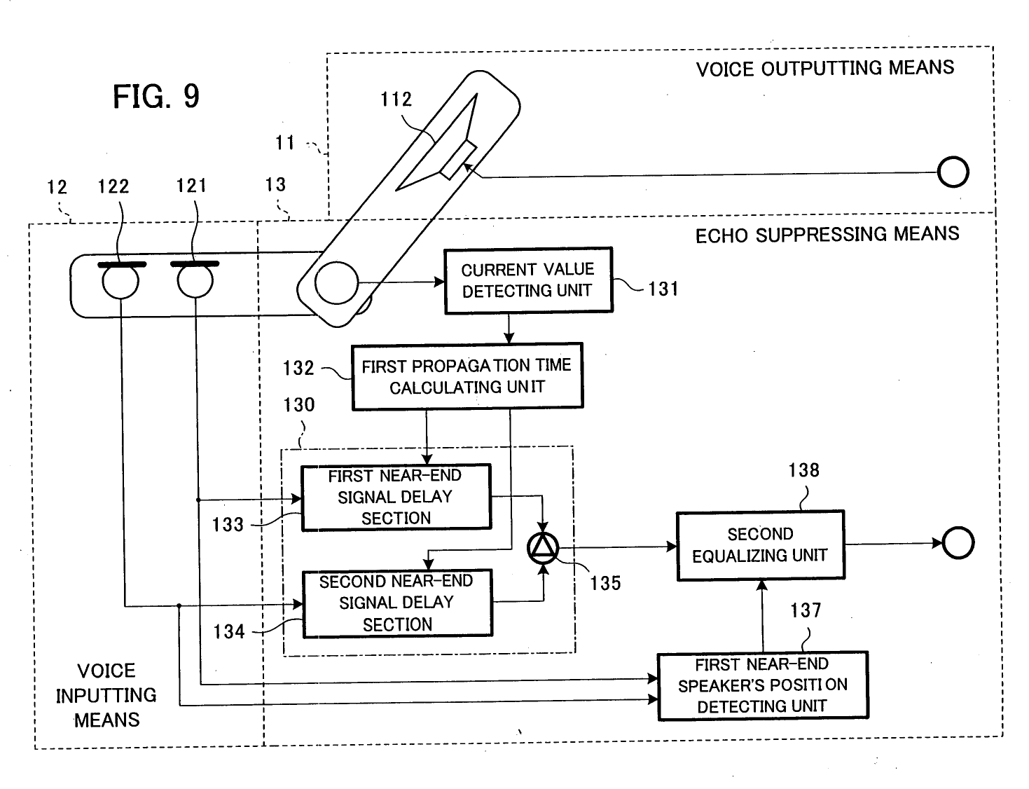

As shown in FIG. 9, the echo suppressing means 13 of the voice communication apparatus according to the first embodiment of the present invention may include a first near-end speaker's position detecting unit 137 for detecting, as a first near-end speaker's position, a position of the near-end speaker to either the first near-end voice converting unit 121 or the second near-end voice converting unit 122 on the basis of the cross-correlation function between the first near-end signal converted by the first near-end voice converting unit 121 and the second near-end signal converted by the second near-end voice converting unit 122, and a second equalizing unit 138 for equalizing a frequency spectrum of the first suppressed near-end signal outputted by the first suppressed near-end signal outputting unit 130 on the basis of the current parameter value detected by the current value detecting unit 131 and the position of the neat-end speaker detected by the first near-end speaker's position detecting unit 137.

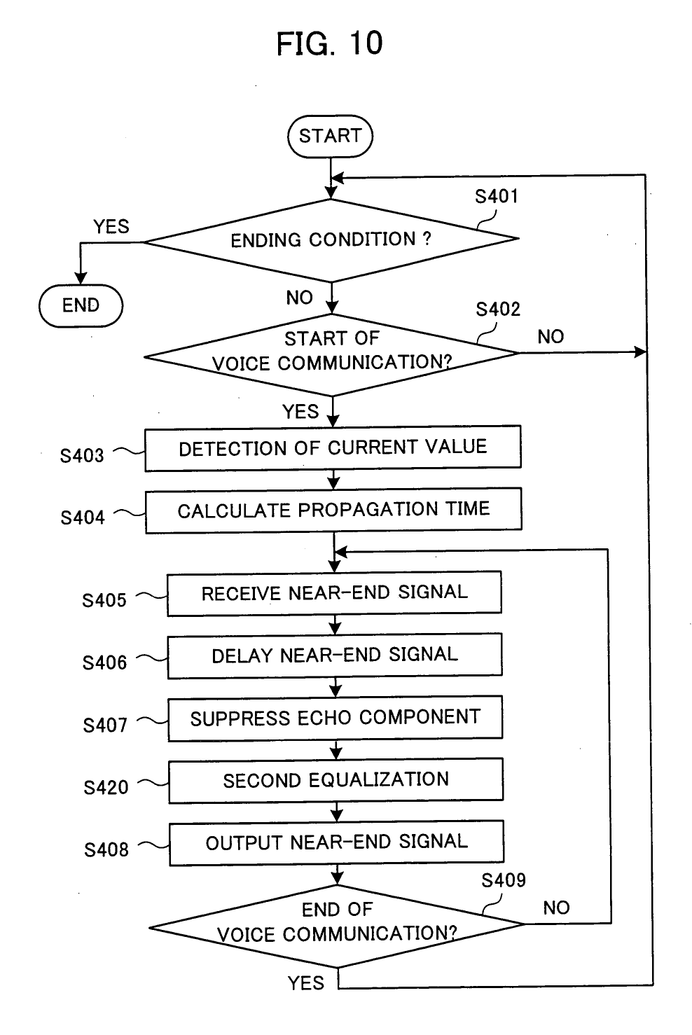

The operation of the voice communication apparatus shown in the flowchart of FIG. 10 is the same as the operation of the voice communication apparatus shown in the flowchart of FIG. 4 with the exception of the operation to be performed (in step S420) by the second equalizing unit 138 for equalizing the frequency spectrum of the suppressed near-end signal. The operation to be performed in the steps S401 to S407, S408 and S409 shown in FIG. 10 are substantially the same as the operation to be performed in the steps S401 to S407, S408 and S409 shown in FIG. 4. Therefore, the operation to be performed in the steps S401 to S407, S408 and S409 shown in FIG. 10 will be described hereinafter.

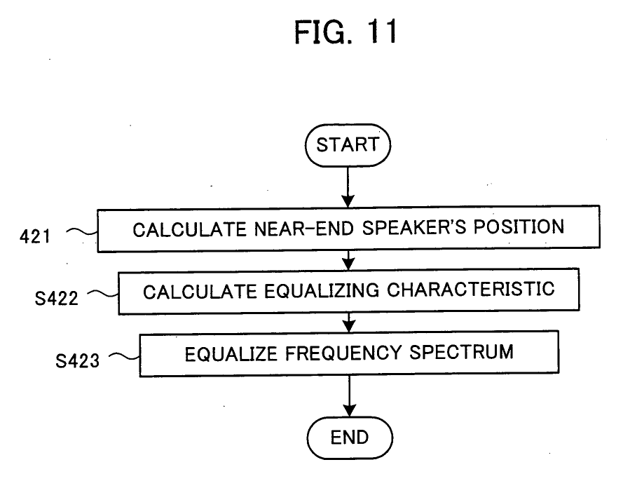

The operation of the second equalizing unit 138 will be then described hereinafter with reference to FIG. 11. The judgment is firstly made on whether or not the far-end signal is detected over a predetermined period. In general, the judgment is made on whether or not the signal level of the far-end signal is equal to or smaller than a predetermined and fixed threshold level. However, the average of the far-end signal detected over a predetermined period may be calculated as a threshold level, if the far-end signal has a noise, before the judgment is made on whether or not the far-end signal is equal to or smaller than the calculated threshold level.

When the judgment is made that the far-end signal is not detected over the predetermined period, the judgment is made on whether or not the near-end sound is detected. Here, the judgment may be made on whether or not the signal level of the near-end signal is equal to or smaller than a fixed threshold level or a threshold level determined with the average of the near-end signal detected over a predetermined period. If the near-end signal has a relatively high background noise, the white cross-correlation may be calculated before the maximum value of the cross-correlation is equal to or larger than a reference value (0.5 to 0.7).

Here, the term “white cross-correlation function” is intended to indicate a function defining an inverse Fourier transformation of the normalization of a cross-spectrum between the first near-end signal converted by the first near-end voice converting unit 121 and the second near-end signal converted by the second near-end voice converting unit 122 with respect to the product of the first near-end signal converted by the first near-end voice converting unit 121 and the second near-end signal converted by the second near-end voice converting unit 122.

When the judgment is made that the near-end sound is being detected under the condition that the far-end signal is not being detected, the white cross-correlation between the first near-end signal converted by the first near-end voice converting unit 121 and the second near-end signal converted by the second near-end voice converting unit 122 is calculated before the first near-end speaker's position indicative of the position of the near-end speaker to either the first near-end voice converting unit 121 or the second near-end voice converting unit 122 is calculated (in step S421). Here, the operation in the above mentioned step S421 is performed by the first near-end speaker's position detecting unit 137.

The equalization characteristic is then calculated from the equalization characteristic stored in advance in the memory unit 231 on the basis of the current parameter value detected by the current value detecting unit 131 and the near-end speaker's position detected by the first near-end speaker's position detecting section 137 (in step S422). The frequency spectrum of the near-end signal is equalized on the basis of the calculated equalization characteristic (in step S423). The above mentioned operation is performed by the second equalizing unit 138.

From the above detail description, it will be understood that the voice communication apparatus can maintain the quality of the near-end voice signal to be transmitted to the far-end speaker by reason that the frequency spectrum of the near-end signal is equalized by the second equalizing unit 138, even if the first reference position is occupied by the near-end speaker, by reason that the echo suppressing means 13 further includes a first near-end speaker's position detecting section 137 and a second equalizing unit 138.

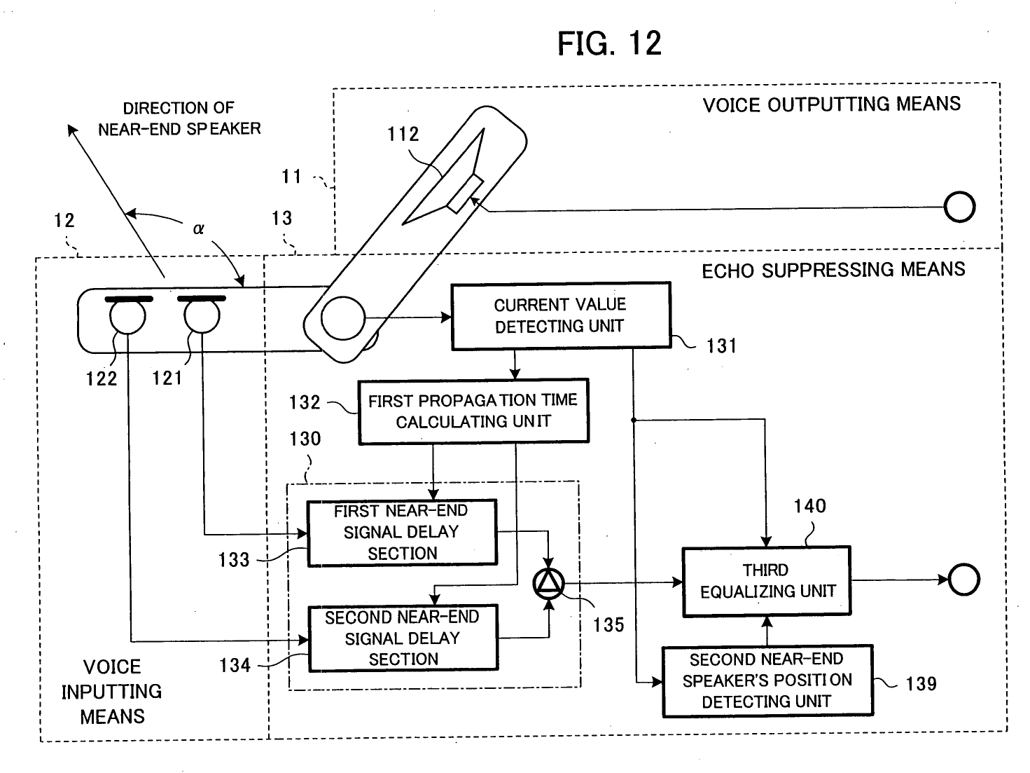

As shown in FIG. 12, the voice communication apparatus according to the first embodiment of the present invention may further include a second near-end speaker's position detecting unit 139 for detecting, as a second near-end speaker's position, a current position of the near-end speaker with respect to the far-end signal converting unit 112 on the basis of the current parameter value detected by the current value detecting unit 131, and a third equalizing unit 140 for equalizing a frequency spectrum of the first suppressed near-end signal outputted by the first suppressed near-end signal outputting unit 130 with respect to the current parameter value detected by the current value detecting unit 131 and the second near-end speaker's position detected by the second near-end speaker's position detecting unit 139.

In the above mentioned voice communication apparatus, the equalization characteristic is calculated with the assumption that the second reference position is occupied by the near-end speaker.

When the above mentioned voice communication apparatus constituted by a mobile phone comprising a housing having two complementary sections is utilized by the near-end speaker, the position of the near-end speaker is in the direction of the angle “α” (see FIGS. 3 and 12). Therefore, the propagation time of the near-end voice to each of the first and second near-end voice converting units 121 and 122 is defined as a function of the angle of the first complementary section 32 with respect to the second complemenray section 33 with the assumption that the second reference position is occupied by the near-end speaker. This means that the angle “α” of the near-end speaker with respect to the second complementary section 33 and the propagation time of the near-end voice to each of the first and second near-end voice converting units 121 and 122 can be calculated on the basis of the current parameter value detected by the current value detecting unit 131.

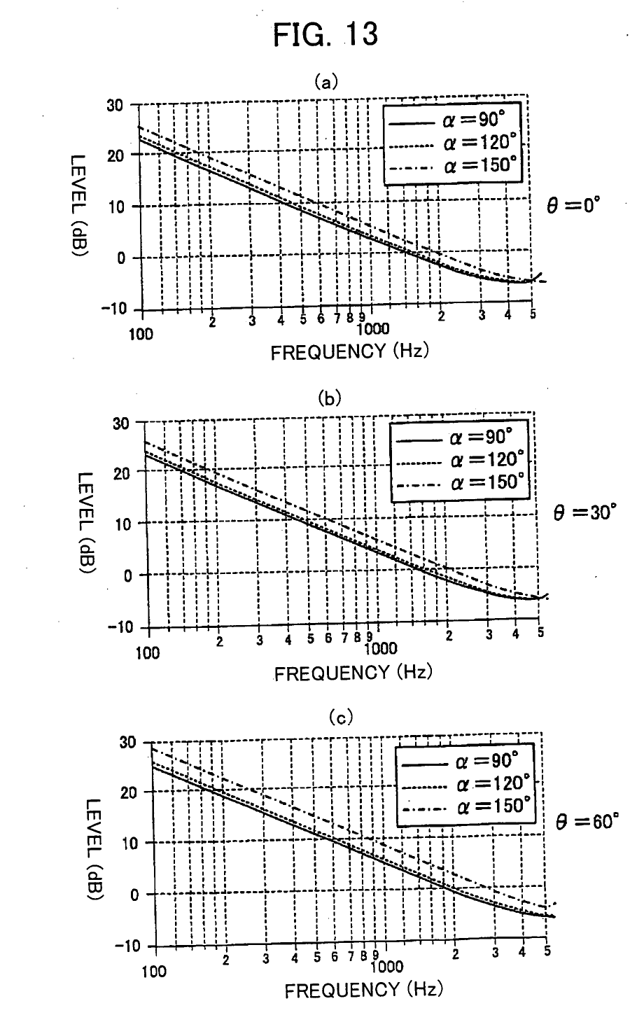

The operation of the third equalizing unit 140 of the above mentioned voice communication apparatus, which is constituted by a mobile phone comprising a housing having two complementary sections, will be described hereinafter with reference to FIGS. 13(a) to 13(c).

The graphs of FIGS. 13(a) to 13(c) shows the frequency spectrum of the suppressed near-end signal in association with respective angles including “0”, “30” and “60” degrees defined as a parameter indicative of the angle of the frist complementary section 32 with respect to the second complementary section 33. The data on the frequency spectrum of the suppressed near-end signal shown in each of the graphs of FIGS. 13(a) to 13(c) is stored in advance in the memory unit 231.

Here, the three different lines including the alternate long and short dash line, the short dashed line and the continuous line represent the frequency spectrum of the suppressed near-end signal in each of the graphs of FIG. 13(a) to 13(c) in association with three different angles including “90”, “120” amd “150” degrees defined as a parameter indicative of the angle of the near-end speaker with respect to the second complementary section 33.

When the judgment is made that the angle of the frist complementary section 32 with respect to the second complementary section 33 is equal to the angle of 30 degrees on the basis of the current parameter value detected by the current value detecting unit 131, and that the angle of the near-end speaker with respect to the second complementary section 33 is equal to the angle of 120 degrees on the basis of the positon of the near-end speaker detected by the second near-end speaker's position detecting unit 139, the equalization characteristic represented by the short dashed line of FIG. 13(b) is selected from among the equalization characteristics represented by the lines of FIG. 13(a) to 13(c). The frequency spectrum of the suppressed near-end signal is then equalized on the basis of the selected equalization characteristic. When, on the other hand, the judgment is made that the equalization characteristic matched with the above mentioned angle is not stored in the meamory unit 231, the equalization characteristic is calculated from the equalization characteristics stored in the memory unit 231 on the basis of the interpolation method.

From the above detail description, it will be understood that the voice communication apparatus according to the first embodiment can maintain the quality of the near-end signal to be transmitted to a far-end speaker even if the near-end speaker is spaced apart from the second reference position by reason that echo suppressing means 13 further includes a second near-end speaker's position detecting unit 139 and a third equalizing unit 140. The second near-end speaker's position detecting unit 139 can be simple in construction in comparison with the first near-end speaker's position detecting unit 137.

### Second Embodiment

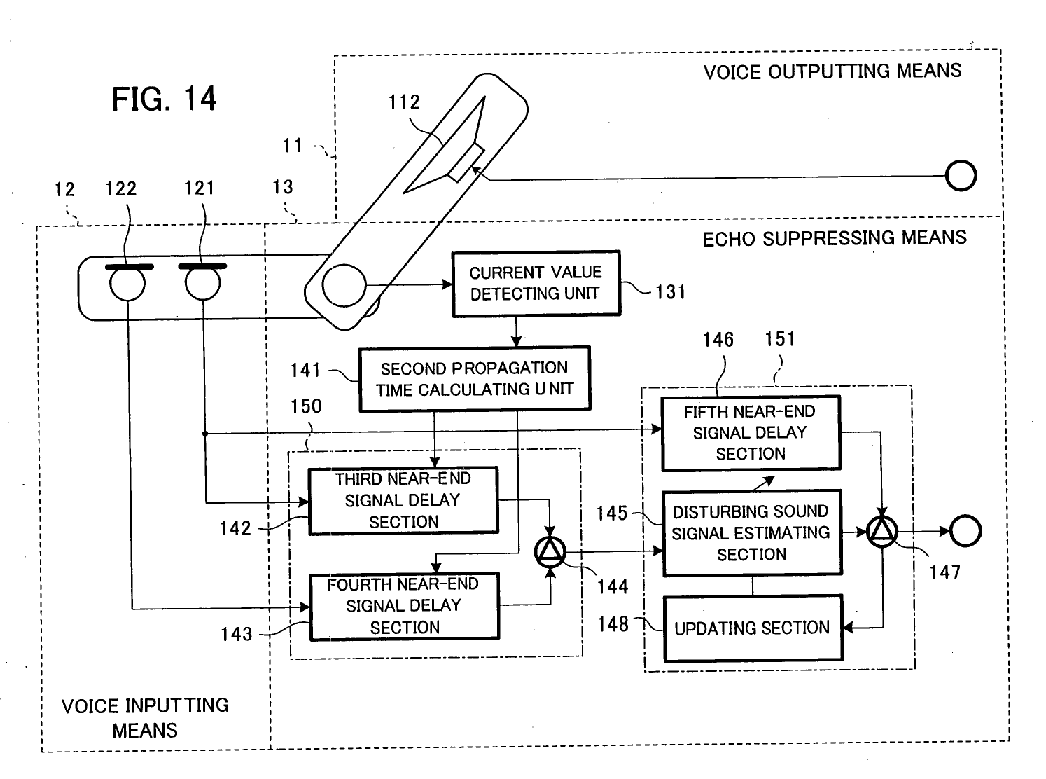

The constitution of the second embodiment of the voice communication apparatus according to the present invention will be then described hereinafter with reference to FIG. 14.

The voice communication apparatus according to the second embedment of the present invention comprises voice outputting means 11 for outputting a far-end voice indicative of a far-end signal, voice inputting means 12 for inputting a near-end voice, and echo suppressing means 13 for suppressing an echo generated by the voice inputting means 12 from the far-end voice outputted by the voice outputting means 11.

The voice outputting means 11 includes a far-end signal converting unit 112 spaced apart from the reference point with a predetermined first distance, and adapted to convert the far-end signal to the far-end voice.

The voice inputting means 12 includes a first near-end voice converting unit 121 spaced apart from the reference point with a predetermined second distance, and adapted to convert the inputted near-end voice to a first near-end signal, and a second near-end voice converting unit 122 disposed at a predetermined position in spaced relationship with the first near-end voice converting unit 121, and adapted to convert the inputted near-end voice to a second near-end signal.

The echo suppressing means 13 includes a current value detecting unit 131 for detecting a current parameter value indicative of a current relative location of either the first near-end voice converting unit 121 or the second near-end voice converting unit 122 with respect to the far-end signal converting unit 112, a second propagation time calculating unit 141 for calculating a third propagation time of the near-end voice to be received by the first near-end voice converting unit 121 with respect to the current parameter value detected by the current value detecting unit 131 on the basis of a third function to be provided with the parameter value defined as its independent variable and the third propagation time defined as its dependent variable, and a fourth propagation time of the near-end voice to be received by the second near-end voice converting unit 122 with respect to the current parameter value detected by the current value detecting unit 131 on the basis of a fourth function to be provided with the parameter value defined as its independent variable and the fourth propagation time defined as its dependent variable, a remaining voice signal extracting unit 150 for extracting a remaining voice signal on the basis of its remaining voice signal extracting characteristic updated in response to the third and fourth propagation time calculated by the second propagation time calculating unit 141, and a second suppressed near-end signal outputting unit 151 for outputting a second suppressed near-end signal by subtracting the remaining voice signal extracted by the remaining voice signal extracting unit 150 from either the first near-end signal converted by the first near-end voice converting unit 121 or the second near-end signal converted by the second near-end voice converting unit 122.

The remaining voice signal extracting unit 150 includes a third near-end signal delay section 142 for delaying the first near-end signal converted by the first near-end voice converting unit 121 on the basis of the third propagation time calculated by the second propagation time calculating unit 141, a fourth near-end signal delay section 143 for delaying the second near-end signal converted by the second near-end voice converting unit 122 on the basis of the fourth propagation time calculated by the second propagation time calculating unit 141, and a remaining voice signal outputting section 144 for outputting, as a remaining voice signal, a signal indicative of the signal difference between the first near-end signal delayed by the first near-end signal delay section 133 and the second near-end signal delayed by the second near-end signal delay section 134.

The second suppressed near-end signal outputting unit 151 includes a disturbing sound signal estimating section 145 for estimating a disturbing sound signal in either the first near-end signal converted by the first near-end voice converting unit 121 or the second near-end signal converted by the second near-end voice converting unit 122 on the basis of the remaining voice signal outputted by the remaining voice signal outputting section 144, a fifth near-end signal delay section 146 for delaying either the first near-end signal converted by the first near-end voice converting unit 121 or the second near-end signal converted by the second near-end voice converting unit 122 with a delay time required to performing the estimation of the interfering near-end signal by the disturbing sound signal estimating section 145, a second outputting section 147 for outputting a second suppressed near-end signal by subtracting the disturbing sound signal estimated by the disturbing sound signal estimating section 145 from the near-end signal delayed, as a fifth delayed near-end signal, by the fifth near-end signal delay section 146, and an updating section 148 for sequentially updating the disturbing sound signal estimating characteristic of the disturbing sound signal estimating section 145 by performing the least squares estimation of the second suppressed near-end signal.

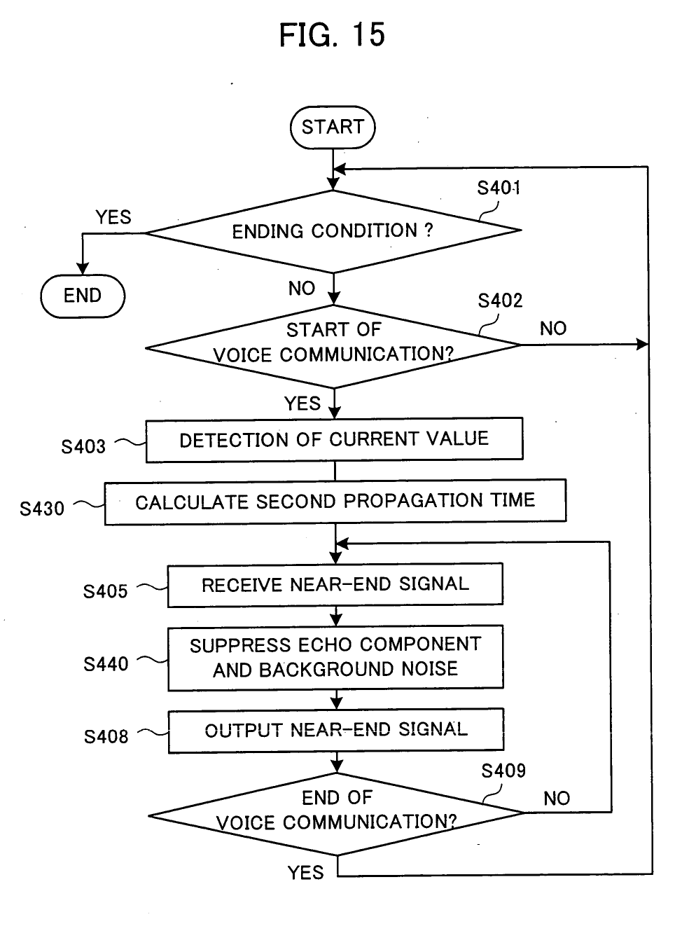

The operation of the echo suppressing means 13 of the voice communication apparatus according to the second embodiment of the present invention will be described hereinafter with reference to FIG. 15. The steps S401 to S403 of the voice communication apparatus shown in FIG. 15 are respectively the same as those of the voice communication apparatus according to the first embodiment. Therefore, the steps S401 to S403 shown in FIG. 15 will not described hereinafter.

The third propagation time of the near-end voice to be received by the first near-end voice converting unit 121 and the fourth propagation time of the near-end voice to be received by the second near-end voice converting unit 122 are calculated (in step S430) on the basis of the current parameter value detected in the step S403. If the near-end speaker occupies a second reference point in spaced and face-to-face relationship with the far-end signal converting unit 112, the third propagation time of the near-end voice to be received by the first near-end voice converting unit 121 and the fourth propagation time of the near-end voice to be received by the second near-end voice converting unit 122 can be specified by a function of an angle of either the first near-end voice converting unit 121 or the second near-end voice converting unit 122 with respect to the far-end signal converting unit 112. The above operation in the step S430 is performed by the second propagation time calculating unit 141.

As has been described about the white cross-correlation function in the first embodiment, the third propagation time of the near-end voice to be received by the first near-end voice converting unit 121 and the fourth propagation time of the near-end voice to be received by the second near-end voice converting unit 122 may be also calculated on the basis of the white cross-correlation function. However, the near-end signal to be transmitted to the far-end speaker may be deteriorated in response to the inadequately estimated propagation time just after the near-end speaker starts to communicate with the far-end speaker through the voice communication apparatus according to the present invention.

The near-end signal to be transmitted to the far-end speaker may be deteriorated in response to the propagation time calculated with the assumption that the near-end speaker occupies the second reference point although the near-end speaker is spaced apart from the second reference point.

Accordingly, the propagation time may be calculated with the assumption that the near-end speaker occupies the second reference point when the near-end speaker does not produce a sound to be received by the voice inputting means. When, on the other hand, the near-end speaker produces a sound to be received by the voice inputting means, the propagation time may be calculated on the basis of the white cross-correlation function.

The near-end signals are respectively received from the first and second near-end signal amplifiers 223 and 224 through the A/D converter 233 (in step S405). The echo and background noise of the near-end signal to be transmitted to the far-end speaker is then suppressed (in step S406).

The operation in the step S408 to the final step shown in the FIG. 15 is the same as the operation of the echo communication apparatus according to the second embodiment of the present invention. Therefore, the operation in the step S408 to the final step shown in the FIG. 15 will not described hereinafter.

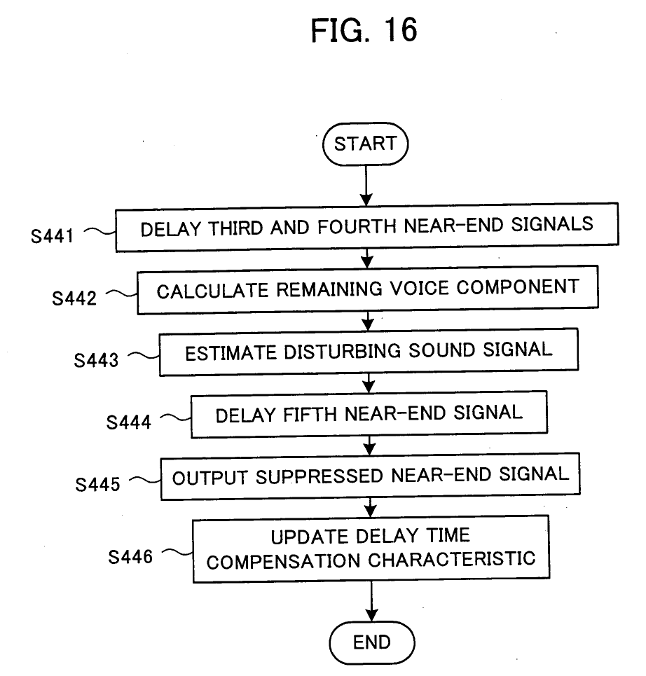

The operation to be performed in the step S440 by the voice communication apparatus according to the second embodiment will be then described hereinafter with reference to FIG. 16.

The near-end signal is firstly delayed on the basis of the propagation time of the near-end sound to be received by either the first near-end voice converting unit 121 or the second near-end voice converting unit 122 (in step S441). The operation in the step S441 is performed by the third and fourth near-end signal delay sections 142 and 143.

The signal difference between the near-end signal delayed and outputted as a first delayed near-end signal by the third near-end signal delay section 142 and the near-end signal delayed and outputted as a first delayed near-end signal by the fourth near-end signal delay section 143 is then calculated and outputted as a remaining voice signal in which the near-end voice component of the near-end signal is canceled (in step S442). The operation in the step S442 is performed by the remaining voice signal outputting section 144.

The disturbing sound signal indicative of the disturbing sound such as a background noise mixed with the far-end voice outputted by the voice outputting means 11 is then estimated in either the first near-end signal or the second near-end signal on the basis of the remaining voice signal outputted by the remaining voice signal outputting section 144 by a conventionally known adaptive filter (in step S443). The operation in the step S443 is performed by the disturbing sound signal estimating section 145.

Either the first near-end signal or the second near-end signal, for example, the first near-end signal converted by the first near-end voice converting unit 121 is delayed with a delay time equivalent to an operation time required for the disturbing sound signal estimating section 145 to perform the estimation of the disturbing sound signal (in step S444). The operation in the step S444 is performed by the fifth near-end signal delay section 146.

The disturbing sound signal estimated in the step S443 is subtracted from the delayed near-end signal. The signal difference between the near-end signal and the disturbed voice signal is then outputted as a signal in which the echo component and the background noise is suppressed (in step S445). The operation in the step S445 is performed by the second outputting section 147.

The disturbing sound signal estimating characteristic of the disturbing sound signal estimating section 145 is sequentially updated (in step S446) in order to minimize the least squares estimation of the suppressed near-end signal, i.e., the disturbing sound signal is minimized the near-end signal under the condition that the near-end voice component of the suppressed near-end signal is not being detected in the near-end signal (in step S446). The operation in the step S446 is performed by the disturbing sound signal estimating characteristic updating section 148.

Here, the disturbing sound signal estimating characteristic of the disturbing sound signal estimating section 145 may be updated on the basis of a conventionally known method such as for example a learning identification method and a first recursive least squares (FRLS) method.

From the above detail description, it will be understood that the voice communication apparatus according to the second embodiment of the present invention can reliably suppress the echo component and the background noise of the near-end signal to be transmitted to the far-end speaker in response to the varied relative location of either the first near-end voice converting unit 121 or the second near-end voice converting unit 122 with respect to the far-end signal converting unit 112 by reason that the echo suppressing means 13 includes a current value detecting unit 131, a second propagation time calculating unit 141, a third near-end signal delay section 142, a fourth near-end signal delay section 143, a remaining voice signal outputting section 144, a disturbing sound signal estimating section 145, a fifth near-end signal delay section 146, a second outputting section 147, and an updating section 148.

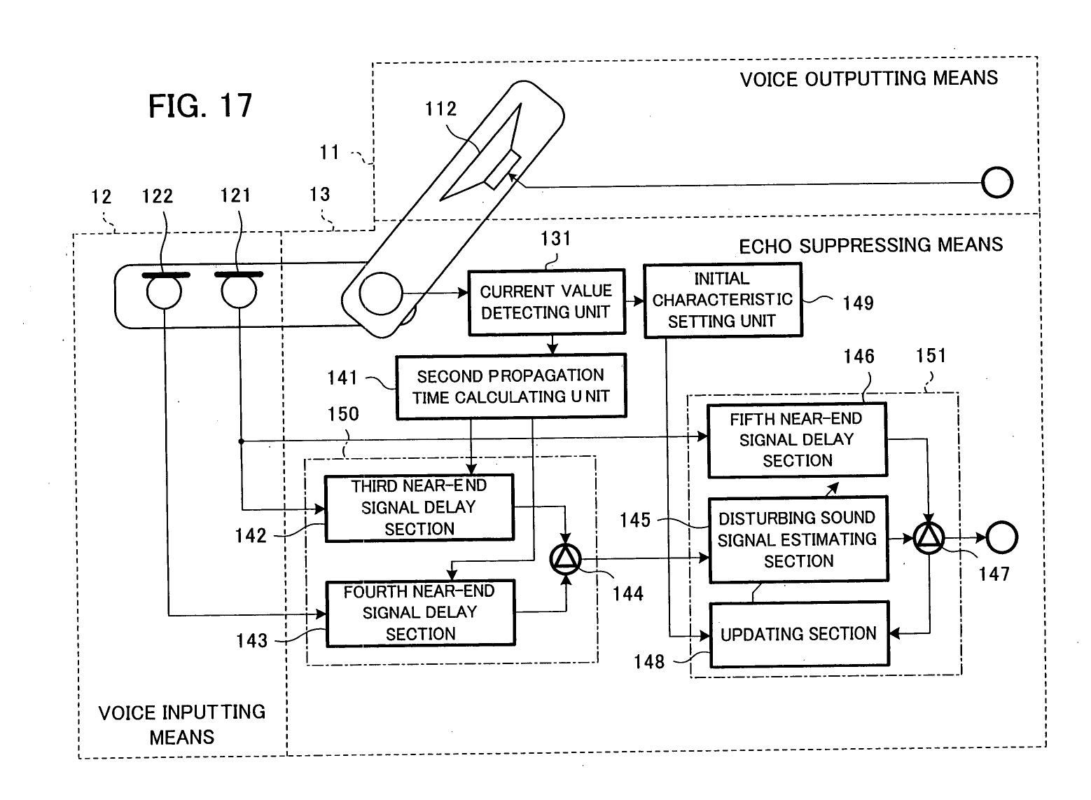

As shown in FIG. 17, the echo suppressing means 13 of the voice communication apparatus according to the second embodiment of the present invention may further includes an initial characteristic setting unit 149 for setting an initial disturbing sound signal estimating characteristic of the updating section 148 on the basis of the current parameter value detected by the current value detecting unit 131.

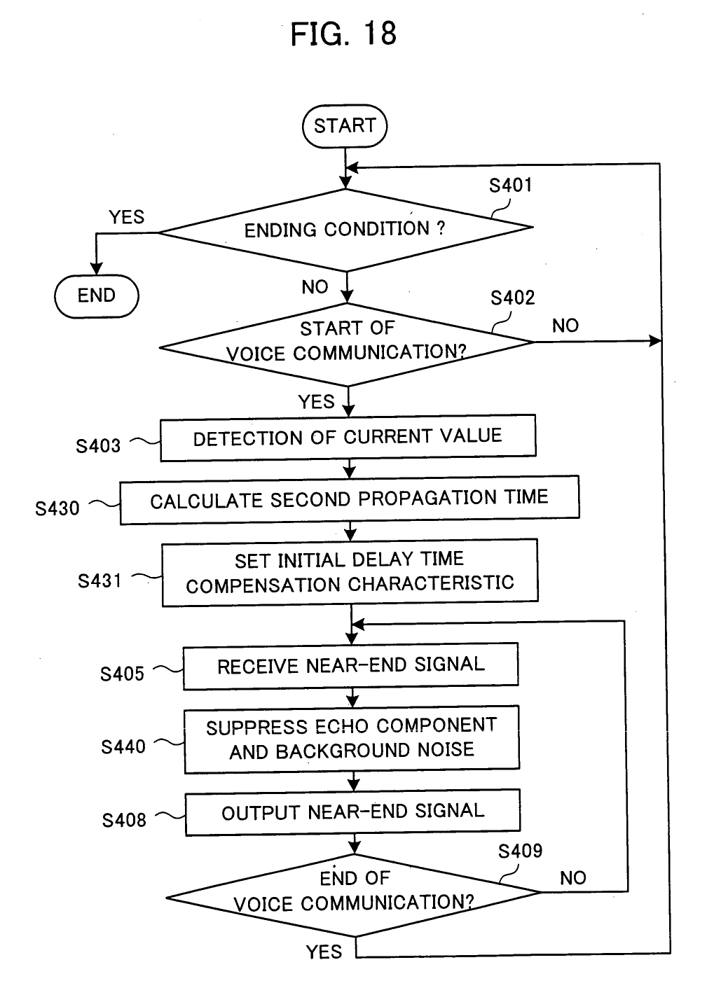

The operation of the echo suppressing means 13 will be then described hereinafter with reference to FIG. 18. The operation to be performed in the steps S401 to S430 is substantially the same as the operation to be performed by the echo suppressing means 13 of the communication apparatus according to the second embodiment. Therefore, the operation to be performed in the steps S401 to S430 will be described hereinafter.

When the second propagation time is calculated in the step S430, the initial disturbing sound signal estimating characteristic of the updating section 148 is set on the basis of the current parameter value detected by the current value detecting unit 131 (in step 431). The operation in the step S431 is performed by the initial characteristic setting unit 149. If there is no information on initial disturbing sound signal estimating characteristic related to the current parameter value detected by the current value detecting unit 131, the information on the initial disturbing sound signal estimating characteristic related to the current parameter value detected by the current value detecting unit 131 is produced from the information on the initial disturbing sound signal estimating characteristic stored in the memory unit 231 on the basis of the interpolation method or other conventional methods.

The operation to be performed in the step S405 and subsequent steps is the same as the operation to be performed in the steps shown in FIG. 15. Therefore, the operation to be performed in the step S405 and subsequent steps will not be described hereinafter.

From the above detail description, it will be understood that the above mentioned voice communication apparatus according to the present invention can rapidly converge the disturbing sound signal estimating characteristic of the disturbing sound signal estimating section 145 to an optimum disturbing sound signal estimating characteristic in which the average of the square of the suppressed near-end signal of the time domain reaches a minimum value, and more reliably suppress the echo component and the background noise of the near-end signal to be transmitted to the far-end speaker by reason that the echo suppressing means 13 further includes an initial characteristic setting unit 149.

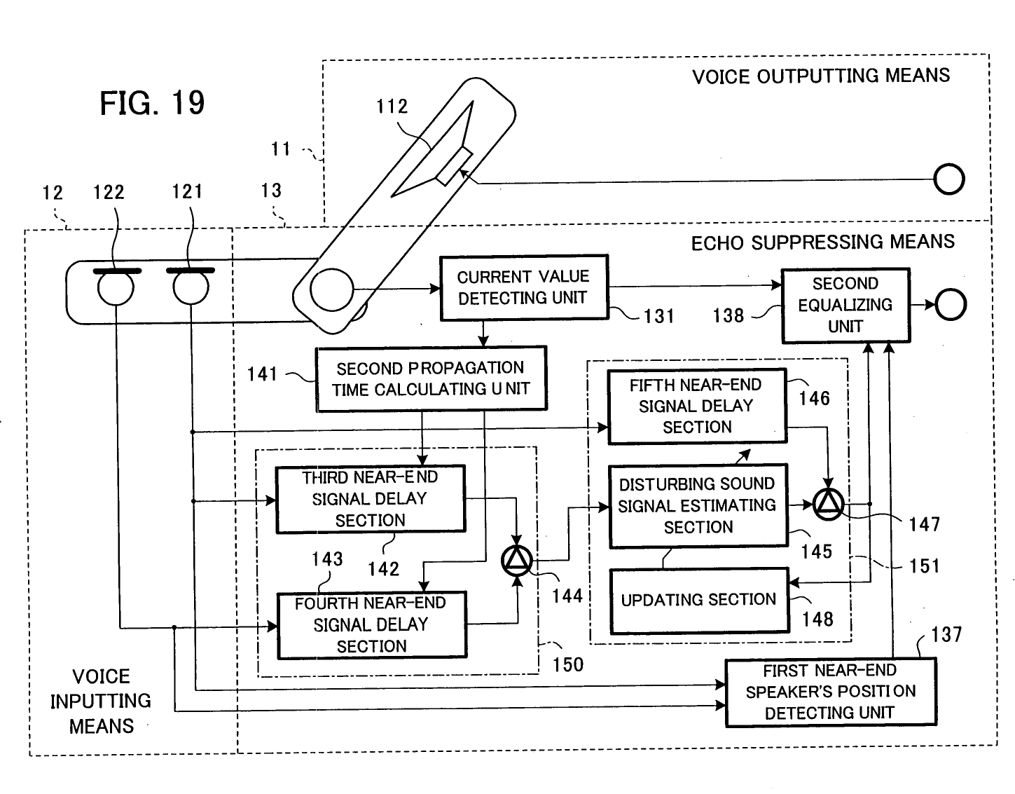

As shown in FIG. 19, the echo suppressing means 13 of the voice communication apparatus according to the second embodiment of the present invention includes a first near-end speaker's position detecting unit 137 for detecting, as a first near-end speaker's position, a position of the near-end speaker with respect to either the first near-end voice converting unit 121 or the second near-end voice converting unit 122 on the basis of the cross-correlation function between the first near-end signal converted by the first near-end voice converting unit 121 and the second near-end signal converted by the second near-end voice converting unit 122, and a second equalizing unit 138 for equalizing a frequency spectrum of the first suppressed near-end signal outputted by the first suppressed near-end signal outputting unit 130 with respect to the current parameter value detected by the current value detecting unit 131 and the position of the near-end speaker detected by the first near-end speaker's position detecting unit 137.

The operation to be performed by the echo suppressing means 13 which includes a second equalizing unit 138, and which is foming part of the voice communication apparatus will be then described with reference to the flowchart of FIG. 20. As shown in FIG. 20, the operation is performed as the second equalization processing between the step S440 and the step S408 (in step S420). The operation to be performed in the steps S401 to S440 and in the step S408 and subsequent steps is the same as the operation to be performed by the echo suppressing means 13 of the voice communication apparatus according to the second embodiment of the present invention. Therefore, the operation to be performed in the steps S401 to S440 and in the step S408 and subsequent steps will not be described hereinafter.

The operation to be performed as the second equalization (in step S420) will be described hereinafter with reference to the flowchart of FIG. 11.

The position of the near-end speaker with respect to the voice inputting means 12 is calculated as a first near-end speaker's position on the basis of the interval between peaks of the white cross-correlation function between the first near-end signal converted by the first near-end voice converting unit 121 and the second near-end signal converted by the second near-end voice converting unit 122 (in step S421). The operation in the step S421 is performed by the first near-end speaker's position detecting unit 137.

The equalization characteristic is calculated from the equalization characteristic stored in the memory unit 231 by the second equalizing unit 138 on the basis of both the current parameter value detected by the current value detecting unit 131 and the first near-end speaker's position detected by the first near-end speaker's position detecting unit 137 (in step S422). The suppressed near-end signal is equalized on the basis of the calculated equalization characteristic (in step S423). The operation in the steps S422 and S423 is performed by the second equalizing unit 138.

From the above detail description, it will be understood that the above mentioned voice communication apparatus according to the present invention can maintain the quality of the near-end voice signal to be transmitted to the far-end speaker even if the near-end speaker is being spaced apart from the first reference point by reason that the echo suppressing means 13 further includes a first near-end speaker's position detecting unit 137 and a second equalizing unit 138.

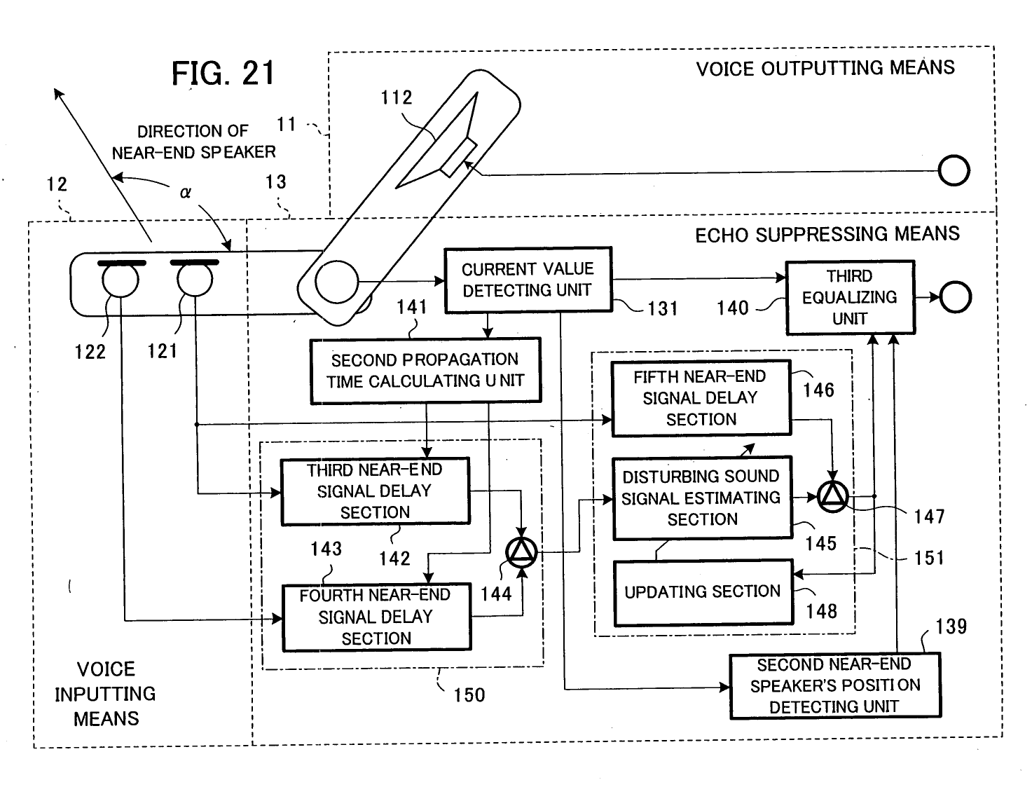

As shown in FIG. 21, the echo suppressing means 13 of the voice communication apparatus according to the second embodiment of the present invention may further include a second near-end speaker's position detecting unit 139 for detecting, as a second near-end speaker's position, a current position of the near-end speaker with respect to the far-end signal converting unit 112 on the basis of the current parameter value detected by the current value detecting unit 131, and a third equalizing unit 140 for equalizing a frequency spectrum of the first suppressed near-end signal outputted by the first suppressed near-end signal outputting unit 130 with respect to the current parameter value detected by the current value detecting unit 131 and the second near-end speaker's position detected by the second near-end speaker's position detecting unit 139.

In this case, the equalization characteristic is determined on the basis of the current parameter value detected by the current value detecting unit 131 with the assumption that the near-end speaker occupies the second reference point in face-to-face relationship with the far-end signal converting unit 112.

As has been described in the first embodiment, the operation is perfomed by the second near-end speaker's position detecting unit 139 with the assumption that the near-end speaker occupies the second reference point in face-to-face relationship with the far-end signal converting unit 112.

From the above detail description, it will be understood that the above mentioned voice communication apparatus according to the present invention can maintain the quality of the near-end signal to be transmitted to the far-end speaker on the basis of the reference frequency spectrum of the near-end voice even if the near-end speaker is being spaced apart from the second reference point by reason that the echo suppressing means 13 includes a second near-end speaker's position detecting unit 139 and a third equalizing unit 140. The second near-end speaker's position detecting unit 139 can be simple in construction in comparison with the first near-end speaker's position detecting unit 137.

In each of the first and second embodiments, the delay time to be set in the near-end signal delay section by the first or second propagation time calculating unit is calculated on the basis of the relative location of either the first near-end voice converting unit or the second near-end voice converting unit with respect to the far-end signal converting unit. However, the delay time may be calculated on the basis of the cross-correlation between the impulse response signal of the first near-end voice converting unit and the impulse response signal of the second near-end voice converting unit under the condtion that the impulse signal is outputted by the far-end signal converting unit.

Each of the first to third equalizing units may be constituted by a conventionally known finite impulse response (FIR) filter. Additionally, each of the first to third equalizing units may be constituted by a conventionally known infinite impulse response (IIR) filter. However, the hardware construction of each of the first to third equalizing units will not described in detail hereinafter.

The equalizing unit constituted by the FIR filter can precisely set the equalization characteristic. On the other hand, the equalizing unit constituted by the IIR filter can reduce the volume of the equalizing operation.

The equalization characteristic is calculated in each of specific frequency ranges by conventionally known filter bank.

In this embodiment, the operation is performed in time domain by the voice communication apparatus by the echo suppressing means of the voice communication apparatus according to the first and second embodiment of the present invention. However, the operation may be performed in frequency domain by the echo suppressing means of the voice communication apparatus according to the first and second embodiment of the present invention. If the operation is performed in the frequency domain, the near-end signal to be transmitted to the far-end speaker is delayed with the time delay equal to the frame length by reason that the near-end signal is divided a plurarity of sequential frames each having a time period, the near-end signal.

It is preferable to determine whether to perform in time domain or in frequency domain on the basis of the application of the voice communication apparatus according to the present invention.

Additionally, the voice outputting means includes a speaker unit as a far-end signal converting unit in the voice communication apparatus according to the present invention. However, the voice outputting means may be include a plurality of speaker units correctively equivalent to the far-end signal converting unit.

### Third Embodiment

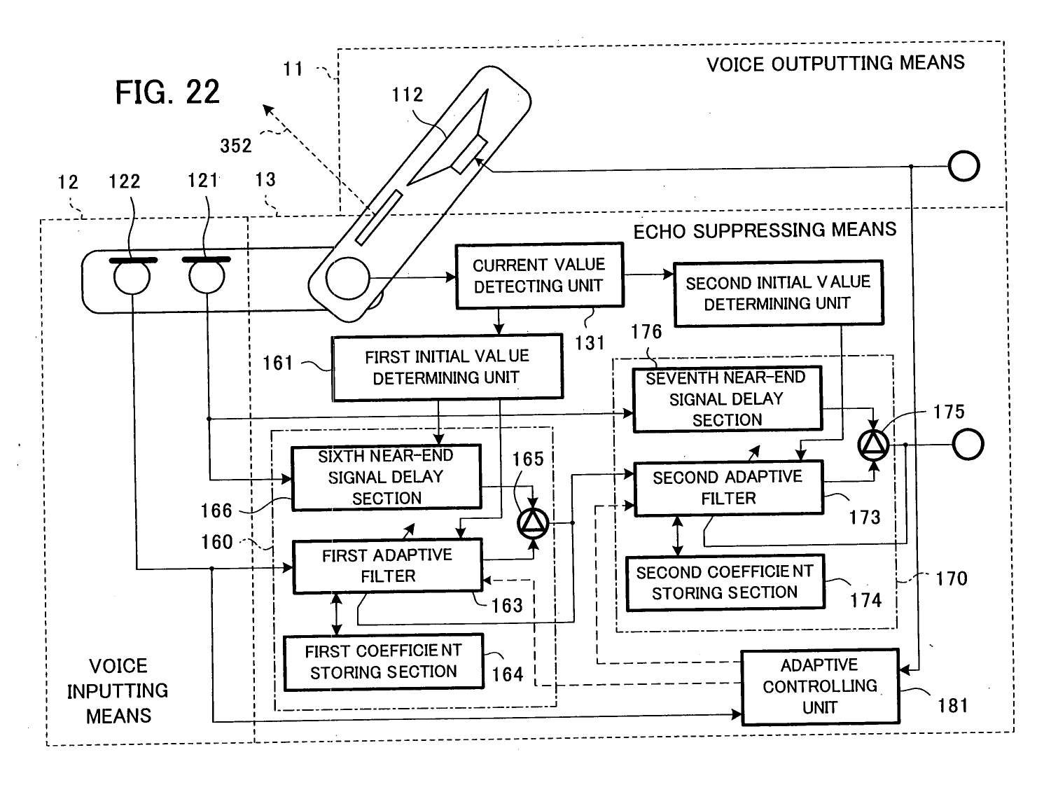

The constitution of the third embodiment of the voice communication apparatus according to the present invention will be described hereinafter with reference to FIG. 22.

The constitutional elements of the voice communication apparatus according to the third embodiment are substantially the same as those of the voice communication apparatus according to each of the first and second embodiments except for the constitutional elements appearing in the following description. Therefore, the constitutional elements of the voice communication apparatus according to the third embodiment the same as those of the voice communication apparatus according to each of the first and second embodiments will not be described but bear the same reference numerals and legends as those of the voice communication apparatus according to each of the first and second embodiments. The voice communication apparatus according to the third embedment of the present invention comprises voice outputting means 11 for outputting a far-end voice indicative of a far-end signal, voice inputting means 12 for inputting a near-end voice, and echo suppressing means 13 for suppressing an echo generated by the voice inputting means 12 from the far-end voice outputted by the voice outputting means 11.

The voice outputting means 11 includes a far-end signal converting unit 112 spaced apart from the reference point with a predetermined first distance, and adapted to convert the far-end signal to the far-end voice.

The voice inputting means 12 includes a first near-end voice converting unit 121 spaced apart from the reference point with a predetermined second distance, and adapted to convert the inputted near-end voice to a first near-end signal, and a second near-end voice converting unit 122 disposed at a predetermined position in spaced relationship with the first near-end voice converting unit 121, and adapted to convert the inputted near-end voice to a second near-end signal.

The echo suppressing means 13 includes an echo component detecting unit 160 for detecting, as an echo component signal, a component other than a real near-end voice to be specified as a cross-component in each of the first and second near-end signals on the basis of the first and second near-end signals respectively converted by the first and second near-end voice converting units 121 and 122, and a third suppressed near-end signal outputting unit 170 for outputting a third suppressed near-end signal by subtracting the echo component signal detected by the echo component detecting unit 160 from either the first near-end signal converted by the first near-end voice converting unit 121 or the second near-end signal converted by the second near-end voice converting unit 122. Here, the term “echo component signal” is intended to indicate a signal indicative of the remaining component other than the near-end voice component. More specifically, the echo component signal includes not only an echo component to be narrowly specified in near-end signal, but also a noise such as for example a background noise.

The voice communication apparatus according to the third embodiment of the present invention is exemplified by a mobile phone which is shown in FIG. 3 as comprising a housing having two complementary sections 32 and 33, and a hinge 31 intervening between the two complementary sections 32 and 33 to allow the complementary sections 32 and 33 to be angularly displaced with each other. As shown in FIG. 22, the housing may be provided with a display section 341. Here, the reference number 352 is shown as a direction of the near-end speaker with respect to the voice communication apparatus.

The echo component detecting unit 160 includes a real near-end voice estimating section for estimating, as a real near-end signal, a real near-end voice to be specified as a cross-component in each of the first and second near-end signals respectively converted by the first and second near-end voice converting units 121 and 122, a sixth sixth near-end signal delay section 166 for delaying either the first near-end signal converted by the first near-end voice converting unit 121 or the second near-end signal converted by the second near-end voice converting unit 122 with a delay time required to perform the estimation of the real near-end signal by the real near-end voice estimating section, and an echo component signal outputting section 165 for outputting, as a first echo component signal, a signal indicative of the signal difference between the near-end signal delayed as a sixth delayed near-end signal by the sixth near-end signal delay section 166 and the real near-end signal estimated by the real near-end voice estimating section. The real near-end voice estimating section has a first adaptive filter 163 for executing an adaptive signal processing of either the first near-end signal converted by the first near-end voice converting unit 121 or the second near-end signal converted by the second near-end voice converting unit 122, and a first coefficient storing section 164 for storing information indicative of first coefficients as a parameter of the adaptive signal processing to be executed by the first adaptive filter 163.

The third suppressed near-end signal outputting unit 170 includes an echo component estimating section for estimating, as a second echo component signal, a signal to be specified as a component other than the real near-end voice in either the first near-end signal converted by the first near-end voice converting unit 121 or the second near-end signal converted by the second near-end voice converting unit 122 on the basis of the echo component signal outputted by the echo component signal outputting section 165, a seventh near-end signal delay section 176 for delaying either the first near-end signal converted by the first near-end voice converting unit 121 or the second near-end signal converted by the second near-end voice converting unit 122 with a delay time required to performing the estimation of the echo component signal by the echo component estimating section, and a third outputting section 175 for outputting a third suppressed near-end signal by subtracting the second echo component signal estimated by the echo component estimating section from the near-end signal delayed as a seventh delayed near-end signal by the seventh near-end signal delay section 176.

The echo component estimating section is constituted by two different elements including a second adaptive filter 173 for adaptively processing the echo component signal outputted by the echo component signal outputting section 165, and a second coefficient storing section 174 for storing information indicative of second filter coefficients to be received as a parameter of the adaptive signal processing by the second adaptive filter 173. The second adaptive filter 173 is operative to perform the adaptive filterring operation to minimize the absolute value of the signal difference outputted by the third outputting section 175.

The echo suppressing means 13 includes a current value detecting unit 131 for detecting a current parameter value indicative of a current relative location of either the first near-end voice converting unit 121 or the second near-end voice converting unit 122 with respect to the far-end signal converting unit 112, a first initial value determining unit 161 for determining, as a parameter of the adaptive signal processing, initial filter coefficients of the first adaptive filter 163 in response to the current parameter value detected by the current value detecting unit 131, and a second initial value determining unit 171 for determining, as a parameter of the adaptive signal processing, initial filter coefficients of the second adaptive filter 173 in response to the current parameter value detected by the current value detecting unit 131.

The echo suppressing means 13 includes an adaptive controlling unit 181 for issuing an instruction to the first adaptive filter 163 to update the first filter coefficients when the judgment is made that the near-end signal predetermined as one of the first and second near-end signals exceeds in amplitude the far-end signal, and issuing an instruction to the second adaptive filter 173 to update the second filter coefficients when the judgment is made that the far-end signal exceeds in amplitude one of the first and second near-end signals.

The flows of the signals respectively outputted by the constitutional elements of the voice communication apparatus according to the present invention will be then described hereinafter. The signal is outputted to the first adaptive filter 163 from the second near-end voice converting unit 122. Here, the first adaptive filter 163 is electrically connected to the first coefficient storing section 164. The signal is outputted to the echo component signal outputting section 165 from the sixth near-end signal delay section 166, while the signal is outputted to the echo component signal outputting section 165 from the first adaptive filter 163.

The signal is outputted to each of the first and second adaptive filters 163 and 173 from the echo component signal outputting section 165. Here, the second adaptive filter 173 is electrically connected to the second coefficient storing section 174. The filter coefficient information is received from the second coefficient storing section 174 by the second adaptive filter 173. The signal is outputted to the third outputting section 175 from the seventh near-end signal delay section 176, while the signal is outputted to the third outputting section 175 from the second adaptive filter 173.

The signal is outputted to the second adaptive filter 173 from the third outputting section 175, and transmitted as an echo suppressed signal to the far-end speaker from the third outputting section 175. The hinge 31 is connected as housing state detecting means to the current value detecting unit 131, while the current parameter value is detected as a parameter related to the current angle between the first and second complementary sections 32 and 33 by the current value detecting unit 131.

The signal is outputted to the first adaptive filter 163 from the first initial value determining unit 161, while the signal is outputted to the second adaptive filter 173 from the second initial value determining unit 171. The far-end signal is received by the adaptive controlling unit 181 from the far-end signal converting unit 112, while the second near-end signal is received by the adaptive controlling unit 181 from the second near-end voice converting unit 122. The signal is outputted to the first adaptive filter 163 from the adaptive controlling unit 181, while the signal is outputted to the second adaptive filter 173 from the adaptive controlling unit 181.

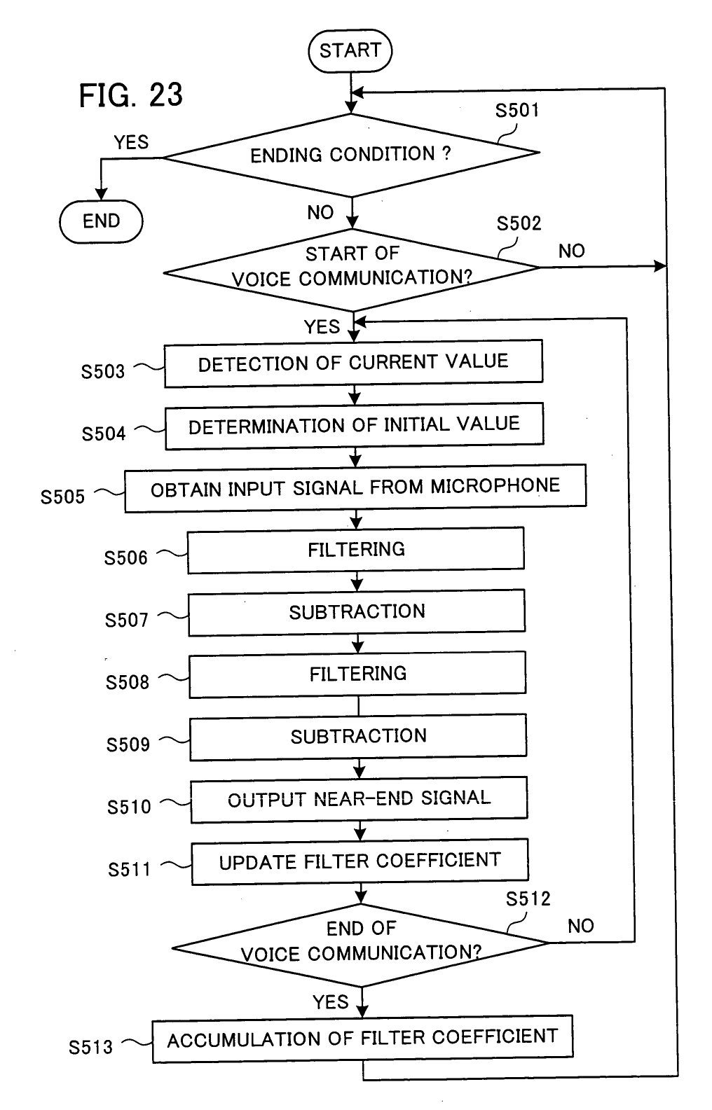

The operation of the voice communication apparatus thus constructed as previously mentioned will be described hereinafter with reference to FIG. 23. The judgment is firstly made by the echo suppressing means 13 on whether or not voice communication ending conditions are fulfilled in the voice communication apparatus, for example, on whether or not the voice communication apparatus is turned off (in step S501). When the judgment is made in the step S501 that the voice communication ending conditions are fulfilled in the voice communication apparatus, the echo suppressing means 13 is operated to stop the operation of suppressing the echo component of the near-end signal. When, on the other hand, judgment is made in the step S501 that the voice communication ending conditions are not fulfilled in the voice communication apparatus, the step S501 proceeds to the step S502.

When the judgment is made in the step S501 that the voice communication ending conditions are not fulfilled in the voice communication apparatus, the judgment is made by the echo suppressing means 13 on whether or not the voice communication is started between the far-end speaker and the near-end speaker by judging whether or not the signal level of the near-end signal is equal to or smaller than a predetermine threshold level (in step S502). When the judgment is made in the step S502 that the voice communication is started between the far-end speaker and the near-end speaker on the basis of the signal level of the near-end signal, the step S502 proceeds to the step S503. When, on the other hand, the judgment is made in the step S502 that the voice communication is not started between the far-end speaker and the near-end speaker on the basis of the signal level of the near-end signal, the step S502 proceeds to the step S501.

When the judgment is made in the step S502 that the voice communication is started between the far-end speaker and the near-end speaker, the current parameter value is detected by the current value detecting unit 131 as a current state of the housing. The current angle between the first and second complementary sections 32 and 33 is calculated on the basis of the current parameter value detected by the current value detecting unit 131. Here, the current value detecting unit 131 may be realized by a rotary encoder, variable resister, or other converter for converting the current angle of the hinge 31 to an electric signal. Additionally, the parameter value indicative of the relative location of either the first near-end voice converting unit 121 or the second near-end voice converting unit 122 with respect to the far-end signal converting unit 112 may be detected in a discontinuous manner by the current value detecting unit 131. For example, the current value detecting unit 131 may be replaced by a detecting element for detecting whether the housing is in an open state or in a closed state.

The initial values of the first and second filter coefficients to be respectively outputted to the first and second adaptive filters 163 and 173 are respectively determined by the first and second initial value determining units 161 and 171 on the basis of the current parameter value detected by the current value detecting unit 131 (in step S504).

More specifically, the first initial value determining unit 161 is operated to output a signal related to the current angle of the housing (hereinafter referred to as “angle signal”) to the first adaptive filter 163, while the first adaptive filter 163 is operated to receive the filter coefficient from the first coefficient storing section 164 in response to the angle signal received from the first initial value determining unit 161. Here, the filter coefficients respectively related to the predetermined angles may be stored in advance in the first coefficient storing section 164, while the first adaptive filter 163 may be operated to select one filter coefficient from among the filter coefficients stored in the first coefficient storing section 164 on the basis of the angle signal received from the first initial value determining unit 161 and the interpolation method or other conventional methods.

On the other hand, the second initial value determining unit 171 is operated to output an angle signal related to the current angle of the housing to the second adaptive filter 173, while the second adaptive filter 173 is operated to receive the filter coefficient from the second coefficient storing section 174 in response to the angle signal received from the second initial value determining unit 171. Here, the filter coefficients respectively related to the predetermined angles may be stored in advance in the second coefficient storing section 174, while the second adaptive filter 173 may be operated to select one filter coefficient from among the filter coefficients stored in the second coefficient storing section 174 on the basis of the angle signal received from the second initial value determining unit 171 and the interpolation method or other conventional methods.

When the initial values of the first and second filter coefficients are respectively determined by the first and second initial value determining units 161 and 171 in the step S504, the near-end sound is received by each of the first and second near-end voice converting units 121 and 122, and converted to the first and second near-end signals (in step S505). Each of the first and second near-end signals converted by the first and second near-end voice converting units 121 and 122 is converted to a digital signal by an analogue-to-digital converter (not shown). Here, each of the first and second near-end signals may be processed as an analogue signal in the step S506 and subsequent steps.

In general, the voice communication apparatus is partially constituted by a microcomputer or a digital signal processor (DSP) to execute an echo-suppressing program to perform the operation in the step S506 and subsequent steps.

The first and second near-end signals digitized by the A/D converter are processed in time domain in following steps. Each of the first and second near-end signals is discretely processed as a time domain analysis at a sampling rate of the A/D converter. If each of the first and second near-end signals digitized by the A/D converter are processed in frequency domain, each of the first and second near-end signals digitized by the A/D converter is divided into frames having respective periods. Each of the first and second near-end signals divided into the frames is sequentially processed as a frequency domain analysis. The frequency domain analysis can shorten processing time of echo suppression in comparison with the time domain analysis. On the other hand, the near-end signal to be transmitted to the far-end speaker is delayed with the delay time equal to the period of each of the frames if the near-end signal to be transmitted to the far-end speaker is processed in the frequency domain.

The first near-end signal digitized in the step S505 is delayed with a predetermined delay time by the sixth near-end signal delay section 166, while the second near-end signal digitized in the step S505 is adaptively processed (in step S506). It is preferable that the predetermined delay time of the sixth near-end signal delay section 166 is equal to the coefficient length of the first adaptive filter 163. More specifically, the predetermined delay time of the sixth near-end signal delay section 166 is roughly equal to half of a tap length of the first adaptive filter 163.

It is preferable that the first near-end signal digitized in the step S505 may be delayed by a buffer memory with the delay time equal to the integral multiple of the sampling rate of the A/D converter 233. The convolution of the first filter coefficient to the second near-end signal digitized in the step S505 is performed by the first adaptive filter 163.

Each of the first near-end signal delayed in the step S506 and the second near-end signal adaptively processed by the first adaptive filter 163 in the step S506 is then received by the echo component signal outputting section 165. The signal difference between the first near-end signal delayed in the step S506 and the second near-end signal adaptively processed by the first adaptive filter 163 in the step S506 is then calculated by the echo component signal outputting section 165 (in step S507). The signal indicative of the signal difference calculated by the echo component signal outputting section 165 in the step S507 is fed back to the first adaptive filter 163. The first adaptive filter 163 is then operated to adaptively process the second near-end signal to minimize the absolute value of the signal difference between the first near-end signal delayed in the step S506 and the second near-end signal adaptively processed by the first adaptive filter 163 in the step S506.

The first near-end signal digitized in the step S505 is delayed with a predetermined delay time by the seventh near-end signal delay section 176, while the signal outputted by the echo component signal outputting section 165 is adaptively processed by the second adaptive filter 173 (in step S508). It is preferable that the predetermined delay time of the seventh near-end signal delay section 176 is equal to the coefficient length of the second adaptive filter 173. More specifically, the predetermined delay time of the seventh near-end signal delay section 176 is roughly equal to half of a tap length of the second adaptive filter 173.

It is preferable that the first near-end signal digitized in the step S506 is delayed by a buffer memory with the delay time equal to the integral multiple of the sampling rate of the A/D converter 233. The convolution of the first filter coefficient to the second near-end signal digitized in the step S505 is performed by the first adaptive filter 173.

Each of the first near-end signal delayed in the step S508 and the signal adaptively processed by the second adaptive filter 173 in the step S508 is then received by the third outputting section 175. The signal difference between the first near-end signal delayed in the step S508 and the second near-end signal adaptively processed by the second adaptive filter 173 in the step S508 is then calculated by the third outputting section 175 (in step S509). The signal difference calculated by the third outputting section 175 in the step S509 is fed back to the second adaptive filter 173. The first adaptive filter 173 is then operated to adaptively process the second near-end signal to minimize the absolute value of the signal difference calculated in the step S509.

The signal produced in the step S509 is then outputted as the suppressed near-end signal to the far-end speaker (in step S510).

Each of the first and second filter coefficients of the first and second adaptive filters 163 and 173 is updated after the judgment is made by the adaptive controlling unit 181 on whether or not to update each of the first and second filter coefficients of the first and second adaptive filters 163 and 173 (in step S511). When the answer in the step 511 is in the affirmative, each of the first and second filter coefficients of the first and second adaptive filters 163 and 173 is updated in the step S511. When, on the other hand, the answer in the step 511 is in the negative, each of the first and second filter coefficients of the first and second adaptive filters 163 and 173 is not updated in the step S511.

The following description will be then directed to, as an example, a judging method of the adaptive controlling unit 181. When the judgment is made that the power value of the near-end signal exceeds a first threshold level, and that the cross-correlation between the far-end signal and the near-end sigal outputted by the second near-end voice converting unit 122 exceeds a predetermined threshold level, the judgment is made that the far-end signal exceeds the near-end signal. When, on the other hand, the judgment is made that the power value of the near-end signal does not exceed a second threshold level, and that the power value of the near-end sigal outputted by the second near-end voice converting unit 122 exceeds a third threshold level, the judgment is made that the near-end voice component of the near-end signal exceeds the far-end signal. Here, the judgment may be made by the adaptive controlling unit 181 on whether or not to update each of the first and second filter coefficients of the first and second adaptive filters 163 and 173 by judging whether or not the maximum value of the white cross-correlation between the far-end signal and the near-end sigal outputted by the second near-end voice converting unit 122 exceeds a predetermined threshold level.

Additionally, the judgment may be made that the far-end signal exceeds the near-end signal when the judgment is made that the power value of the near-end signal outputted by the second near-end voice converting unit 122 exceeds the first threshold level, and that the power value of the far-end signal exceeds the second threshold level. On the other hand, the judgment may be made that the near-end signal exceeds the far-end signal when the judgment is made that the power value of the far-end signal does not exceed the third threshold level, and that the power value of the near-end signal outputted by the second near-end voice converting unit 122 exceeds the fourth threshold level.

As will be seen from the above mentioned operation of the adaptive controlling unit 181, the first filter coefficient of the first adaptive filter 163 can be updated when the judgment is made that the near-end signal exceeds the far-end signal. This leads to the fact that the near-end voice component of the near-end signal is estimated by the first adaptive filter 163 on the basis of the updated first filter coefficient. The near-end voice component of the near-end signal is then suppressed in response to the near-end voice component estimated by the first adaptive filter 163 by the echo component signal outputting section 165. Accordingly, the signal is outputted as an estimated echo component signal by the echo component signal outputting section 165.

On the other hand, the second filter coefficient of the second adaptive filter 173 can be updated by the adaptive controlling unit 181 when the judgment is made that the far-end signal exceeds the near-end signal. This leads to the fact that the echo component of the near-end signal is estimated by the second adaptive filter 173 on the basis of the updated second filter coefficient. The echo component of the near-end signal is then suppressed in response to the echo component estimated by the second adaptive filter 173 by the third outputting section 175. Accordingly, the signal is outputted as a near-end sound component signal to be transmitted to the far-end speaker by the third outputting section 175. Here, each of the first filter coefficient of the first adaptive filter 163 and the second filter coefficient of the second adaptive filter 173 may be updated by the adaptive controlling unit 181 on the basis of the conventionally known method such as for example the learning identification method and the first recursive least squares (FRLS) method.

The judgment is then made on whether or not the voice communication is completed between the near-end speaker and the far-end speaker (in step S512) after each of the first and second filter coefficients of the first and second adaptive filters 163 and 173 is updated by the adaptive controlling unit 181 in the step S511. When the judgment is made that the voice communication is completed between the near-end speaker and the far-end speaker, the step S512 proceeds to the step S513. When, on the other hand, the judgment is made that the voice communication is not completed between the near-end speaker and the far-end speaker, the step S512 proceeds to the step S503. The operation is repeatedly performed in the steps S503 to S512. The steps S503 and S504 are skipped in the repeated operation.

When the judgment is made that the voice communication is completed between the near-end speaker and the far-end speaker, the first filter coefficient of the first adaptive filter 163 is stored in the first coefficient storing section 164 in association with the current angle related to the current parameter value detected by the current value detecting unit 131. On the other hand, the second filter coefficient of the second adaptive filter 173 is stored in the second coefficient storing section 174 in association with the current angle related to the current parameter value detected by the current value detecting unit 131.

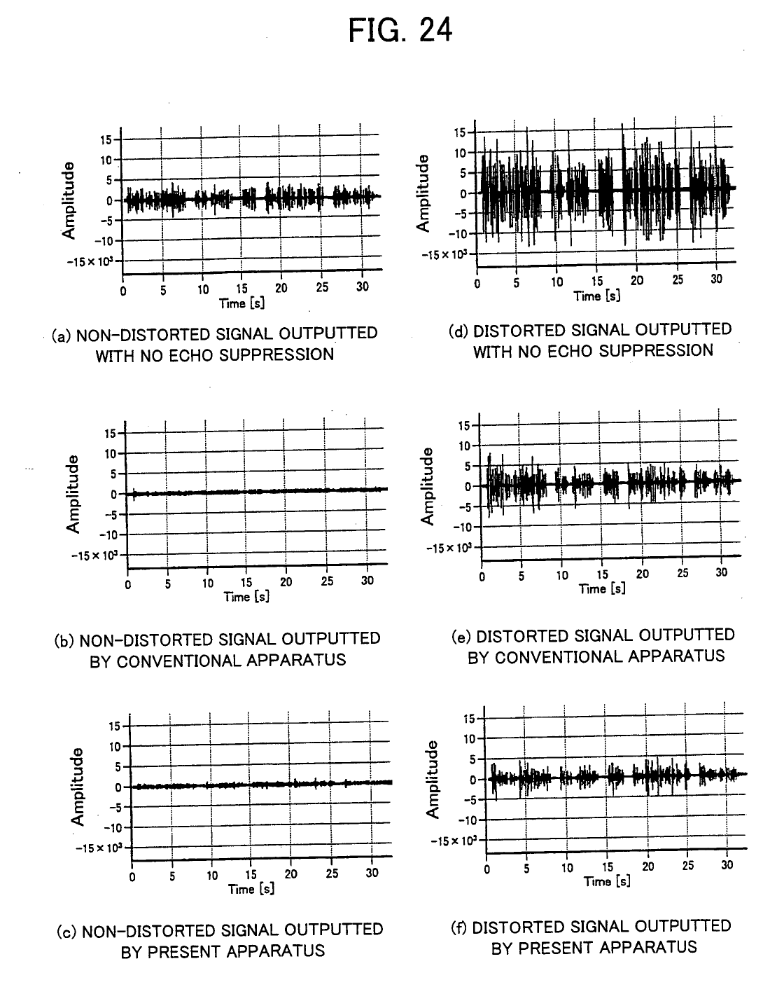

The effects of the voice communication apparatus according to the third embodiment of the present invention will be described hereinafter with reference to FIGS. 24 (a) to 24(f). Here, each of FIGS. 24(a) to 24(c) is a graph showing the near-end signal outputted as a signal to be transmitted to the far-end speaker in response to the far-end voice converted with no distortion, or linearly converted from the far-end signal by the far-end signal converting unit 112.

FIG. 24(a) is a graph showing the near-end signal outputted with no echo suppression as a signal to be transmitted to the far-end speaker in response to the far-end voice converted with no distortion, or linearly converted from the far-end signal. In this case, the far-end voice received from the far-end signal converting unit 112 is superimposed as an echo component on the near-end sound to be converted by each of the first and second near-end voice converting units 121 and 122. The received far-end voice and the near-end sound are collectively converted to the near-end signal to be transmitted to the far-end speaker.

As shown in FIG. 24(a), the quality of the near-end signal to be transmitted to the far-end speaker is deteriorated by the echo component under the condtion that the echo component of the near-end signal is not negligible small in comparison with the near-end voice component of the near-end signal. FIG. 24(b) is a graph showing the near-end signal outputted as a signal to be transmitted to the far-end speaker under the condtion that the echo component of the near-end signal is suppressed by the conventional echo canceller on the basis of the conventional learning identification method. As will be seen from FIG. 24(b), the echo component of the near-end signal can be sufficiently suppressed by the conventional echo canceller.

FIG. 24(c) is a graph showing the near-end signal outputted as a signal to be transmitted to the far-end speaker under the condtion that the echo component of the near-end signal is suppressed by the voice communication apparatus according to the third embodiment of the present invention. As will be seen from FIG. 24(c), the echo component of the near-end signal can be sufficiently suppressed by the voice communication apparatus according to the third embodiment of the present invention.

Each of FIGS. 24(d) to 24(f) is a graph showing the near-end signal outputted as a signal to be transmitted to the far-end speaker in response to the far-end voice converted with distortion, or nonlinearly converted from the far-end signal. FIG. 24(d) is a graph showing the near-end signal outputted with no echo suppression as a signal to be transmitted to the far-end speaker. As will be seen from FIG. 24(d), the near-end signal is outputted with the relatively large echo component.

FIG. 24(e) is a graph showing the near-end signal outputted with echo suppression as a signal to be transmitted to the far-end speaker under the condtion that the echo component of the near-end signal is suppressed by the conventional echo canceller. As will be seen from FIG. 24(e), the echo component can be partially suppressed in the near-end signal to be transmtted to the far-end speaker by the conventional echo canceller by reason that the conventional echo canceller is adapted to linearly suppress the echo component. When, however, the far-end signal is converted with distortion, or nonlinearly converted by the far-end signal convemting unit 112 to a sound to be received by the near-end speaker, the echo component of the near-end signal to be transmitted to the far-end speaker cannot accurately estimated by the conventional echo canceller. This means that the echo component of the near-end signal to be transmitted to the far-end speaker cannot be sufficinently surressed by the conventional echo canceller.

FIG. 24(f) is a graph showing the near-end signal outputted as a signal to be transmitted to the far-end speaker under the condtion that the echo component of the near-end signal is suppressed by the voice communication apparatus according to the third embodiment of the present invention. As will be seen from FIG. 24(f), the voice communication apparatus according to the third embodiment of the present invention cannot perfectly suppress the echo component of the near-end signal to be transmtted to the far-end speaker, but more markedly suppress the echo component of the near-end signal to be transmtted to the far-end speaker in comparison with the conventional echo canceller.

In recent years, there have been proposed a wide variety of downsized mobile phones, and a downsized speaker unit to be built in each of the mobile phones as a voice outputting means 11. Further, the far-end signal tends to be converted with distortion or nonlinearly converted by the downsized speaker unit. The echo component indicative of the distorted far-end sound cannot linearly suppressed by the conventional echo canceller. However, the echo component indicative of the distorted far-end sound can more reliably suppressed by the voice communication apparatus according to the third embodiment of the present inveintion in comparison with the conventional echo canceller.

From the above detail description, it will be understood that the voice communication apparatus according to the third embodiment of the present invention can maintain its echo suppressing characteristic without being affected by the varied relative location of the near-end voice converting unit with respect to the far-end signal converting unit, and maintain the quality of the near-end signal to be transmitted to the far-end speaker by reason that the first adaptive filter is opearive to detect the first echo component related to the current relative location of the near-end voice converting unit with respect to the far-end signal converting unit, the second adaptive filter is opearive to estimate the second echo component of the near-end signal, and the third outputting section is operative to suppress the echo component of the near-end signal.

The voice communication apparatus according to the third embodiment of the present invention can maintain its echo suppressing characteristic without being affected by the varied relative location of the near-end voice converting unit with respect to the far-end signal converting unit, and maintain the quality of the near-end signal to be transmitted to the far-end speaker by reason that the first initial value detemining unit is operative to determine, as a parameter of the adaptive signal processing, initial filter coefficients of the first adaptive filter in response to the current parameter value detected by the current value detecting unit, and the second initial value determining unit is operative to determine, as a parameter of the adaptive signal processing, initial filter coefficients of the second adaptive filter in response to the current parameter value detected by the current value detecting unit.

The voice communication apparatus according to the third embodiment of the present invention can maintain its echo suppressing characteristic by minimizing the second suppressed near-end signal on the basis of the least squares estimation to converge the disturbing sound signal estimating characteristic of the disturbing sound signal estimating section to the optimum disturbing sound signal estimating characteristic in a short period of time, and maintain the quality of the near-end signal to be transmitted to the far-end speaker by reason that the instruction to the first and second adaptive filters to update the first and second filter coefficients is issued by the adaptive controlling unit on the basis of the near-end signal and the far-end signal.

In each of the first to third embodiments of the voice communication apparatus according to the present invention, the position occupied by the first near-end voice converting unit 121 is close to the far-end signal converting unit 112 in comparison with the position occupied by the second near-end voice converting unit 122. However, the position occupied by the second near-end voice converting unit 122 may be close to the far-end signal converting unit 112 in comparison with the position occupied by the first near-end voice converting unit 121.

### INDUSTRIAL APPLICABILITY OF THE PRESENT INVENTION

In accordance with the present invention, there is provided a voice communication apparatus which can maintain its echo suppressing characteristic to suppress the echo component of the near-end signal to be transmitted to the far-end speaker without being affected by the varied relative location of the microphone unit with respect to the speaker unit, and maintain the quality of the near-end signal to be transmitted to the far-end speaker.

What is claimed is:

1. A voice communication apparatus, comprising:
a housing having a reference point;
voice outputting means for outputting a far-end voice indicative of a far-end signal;
voice inputting means for inputting a near-end voice; and
echo suppressing means for suppressing an echo generated by said voice inputting means from said far-end voice outputted by said voice outputting means, wherein
said voice outputting means includes a far-end signal converting unit spaced apart from said reference point with a predetermined first distance, and adapted to convert said far-end signal to said far-end voice,
said voice inputting means includes a first near-end voice converting unit spaced apart from said reference point with a predetermined second distance, and adapted to convert said inputted near-end voice to a first near-end signal, and a second near-end voice converting unit disposed at a predetermined position in spaced relationship with said first near-end voice converting unit, and adapted to convert said inputted near-end voice to a second near-end signal,
said echo suppressing means includes a current value detecting unit for detecting a current parameter value indicative of a current relative location of either said first near-end voice converting unit or said second near-end voice converting unit with respect to said far-end signal converting unit, a first propagation time calculating unit for calculating a first propagation time of said far-end voice converted by said far-end signal converting unit to a distance between said far-end signal converting unit and said first near-end voice converting unit on the basis of a first function to be provided with said parameter value defined as its independent variable and said first propagation time defined as its dependent variable, and a second propagation time of said far-end voice converted by said far-end signal converting unit to a distance between said far-end signal converting unit and said second near-end voice converting unit on the basis of a second function to be provided with said parameter value defined as its independent variable and said second propagation time defined as its dependent variable, and a first suppressed near-end signal outputting unit for outputting a first suppressed near-end signal after suppressing said echo on the basis of its echo suppressing characteristic updated in response to said first and second propagation time calculated by said first propagation time calculating unit.

2. A voice communication apparatus as set forth in claim 1, in which
said first suppressed near-end signal outputting unit includes a first near-end signal delay section for delaying said first near-end signal converted by said first near-end voice converting unit on the basis of said first propagation time calculated by said first propagation time calculating unit, a second near-end signal delay section for delaying said second near-end signal converted by said second near-end voice converting unit on the basis of said second propagation time calculated by said first propagation time calculating unit, and a first outputting section for outputting a signal indicative of the signal difference between said first near-end signal delayed by said first near-end signal delay section and said second near-end signal delayed by said second near-end signal delay section.

3. A voice communication apparatus as set forth in claim 1, in which
said echo suppressing means includes a first equalizing unit for equalizing a frequency spectrum of said first suppressed near-end signal outputted by said first suppressed near-end signal outputting unit with respect to said current parameter value detected by said current value detecting unit.

4. A voice communication apparatus as set forth in claim 1, in which
said echo suppressing means includes a first near-end speaker's position detecting unit for detecting, as a first near-end speaker's position, a position of said near-end speaker with respect to either said first near-end voice converting unit or said second near-end voice converting unit on the basis of the cross-correlation function between said first near-end signal converted by said first near-end voice converting unit and said second near-end signal converted by said second near-end voice converting unit, and a second equalizing unit for equalizing a frequency spectrum of said first suppressed near-end signal outputted by said first suppressed near-end signal outputting unit with respect to said current parameter value detected by said current value detecting unit and said position of said near-end speaker detected by said first near-end speaker's position detecting unit.

5. A voice communication apparatus as set forth in claim 1, in which
said echo suppressing means includes a second near-end speaker's position detecting unit for detecting, as a second near-end speaker's position, a current position of said near-end speaker with respect to said far-end signal converting unit on the basis of said current parameter value detected by said current value detecting unit, and a third equalizing unit for equalizing a frequency spectrum of said first suppressed near-end signal outputted by said first suppressed near-end signal outputting unit with respect to said current parameter value detected by said current value detecting unit and said second near-end speaker's position detected by said second near-end speaker's position detecting unit.

6. A voice communication apparatus, comprising:
a housing having a reference point;
voice outputting means for outputting a far-end voice indicative of a far-end signal;
voice inputting means for inputting a near-end voice; and
echo suppressing means for suppressing an echo generated by said voice inputting means from said far-end voice outputted by said voice outputting means, wherein
said voice outputting means includes a far-end signal converting unit spaced apart from said reference point with a predetermined first distance, and adapted to convert said far-end signal to said far-end voice,
said voice inputting means includes a first near-end voice converting unit spaced apart from said reference point with a predetermined second distance, and adapted to convert said inputted near-end voice to a first near-end signal, and a second near-end voice converting unit disposed at a predetermined position in spaced relationship with said first near-end voice converting unit, and adapted to convert said inputted near-end voice to a second near-end signal,
said echo suppressing means includes a current value detecting unit for detecting a current parameter value indicative of a current relative location of either said first near-end voice converting unit or said second near-end voice converting unit with respect to said far-end signal converting unit, a second propagation time calculating unit for calculating a third propagation time of said near-end voice to be received by said first near-end voice converting unit with respect to said current parameter value detected by said current value detecting unit on the basis of a third function to be provided with said parameter value defined as its independent variable and said third propagation time defined as its dependent variable, and a fourth propagation time of said near-end voice to be received by said second near-end voice converting unit with respect to said current parameter value detected by said current value detecting unit on the basis of a fourth function to be provided with said parameter value defined as its independent variable and said fourth propagation time defined as its dependent variable, a remaining voice signal extracting unit for extracting a remaining voice signal on the basis of its remaining voice signal extracting characteristic updated in response to said third and fourth propagation time calculated by said second propagation time calculating unit, and a second suppressed near-end signal outputting unit for outputting a second suppressed near-end signal by subtracting said remaining voice signal extracted by said remaining voice signal extracting unit from either said first near-end signal converted by said first near-end voice converting unit or said second near-end signal converted by said second near-end voice converting unit.

7. A voice communication apparatus as set forth in claim 6, in which
said remaining voice signal extracting unit includes a third near-end signal delay section for delaying said first near-end signal converted by said first near-end voice converting unit on the basis of said third propagation time calculated by said second propagation time calculating unit, a fourth near-end signal delay section for delaying said second near-end signal converted by said second near-end voice converting unit on the basis of said fourth propagation time calculated by said second propagation time calculating unit, and a remaining voice signal outputting section for outputting, as a remaining voice signal, a signal indicative of the signal difference between said first near-end signal delayed by said first near-end signal delay section and said second near-end signal delayed by said second near-end signal delay section, and in which
said second suppressed near-end signal outputting unit includes a disturbing sound signal estimating section for estimating a disturbing sound signal in either said first near-end signal converted by said first near-end voice converting unit or said second near-end signal converted by said second near-end voice converting unit on the basis of said remaining voice signal outputted by said remaining voice signal outputting section, a fifth near-end signal delay section for delaying either said first near-end signal converted by said first near-end voice converting unit or said second near-end signal converted by said second near-end voice converting unit with a delay time required to performing the estimation of said interfering near-end signal by said disturbing sound signal estimating section, a second outputting section for outputting a second suppressed near-end signal by subtracting said disturbing sound signal estimated by said disturbing sound signal estimating section from said near-end signal delayed, as a fifth delayed near-end signal, by said fifth near-end signal delay section, and an updating section for sequentially updating said disturbing sound signal estimating characteristic of said disturbing sound signal estimating section by performing the least squares estimation of said second suppressed near-end signal.

8. A voice communication apparatus as set forth in claim 7, in which
said echo suppressing means further includes an initial characteristic setting unit for setting an initial disturbing sound signal estimating characteristic of said updating section on the basis of said current parameter value detected by said current value detecting unit.

9. A voice communication apparatus as set forth in claim 6 or claim 7, in which
said echo suppressing means includes a first near-end speaker's position detecting unit for detecting, as a first near-end speaker's position, a position of said near-end speaker with respect to either said first near-end voice converting unit or said second near-end voice converting unit on the basis of the cross-correlation function between said first near-end signal converted by said first near-end voice converting unit and said second near-end signal converted by said second near-end voice converting unit, and a second equalizing unit for equalizing a frequency spectrum of said first suppressed near-end signal outputted by said first suppressed near-end signal outputting unit with respect to said current parameter value detected by said current value detecting unit and said position of said near-end speaker detected by said first near-end speaker's position detecting unit.

10. A voice communication apparatus as set forth in claim 6 or claim 7, in which
said echo suppressing means includes a second near-end speaker's position detecting unit for detecting, as a second near-end speaker's position, a position of said near-end speaker with respect to said far-end signal converting unit on the basis of said current parameter value detected by said current value detecting unit, and a third equalizing unit for equalizing a frequency spectrum of said second suppressed near-end signal outputted by said second suppressed near-end signal outputting unit with respect to said current parameter value detected by said current value detecting unit and said second near-end speaker's position detected by said second near-end speaker's position detecting unit.

11. A voice communication apparatus, comprising:
a housing having a reference point;
voice outputting means for outputting a far-end voice indicative of a far-end signal;
voice inputting means for inputting a near-end voice; and
echo suppressing means for suppressing an echo generated by said voice inputting means from said far-end voice outputted by said voice outputting means, wherein
said voice outputting means includes a far-end signal converting unit spaced apart from said reference point with a predetermined first distance, and adapted to convert said far-end signal to said far-end voice,
said voice inputting means includes a first near-end voice converting unit spaced apart from said reference point with a predetermined second distance, and adapted to convert said inputted near-end voice to a first near-end signal, and a second near-end voice converting unit disposed at a predetermined position in spaced relationship with said first near-end voice converting unit, and adapted to convert said inputted near-end voice to a second near-end signal,
said echo suppressing means includes an echo component detecting unit for detecting, as an echo component signal, a component other than a real near-end voice to be specified as a cross-component in each of said first and second near-end signals on the basis of said first and second near-end signals respectively converted by said first and second near-end voice converting units, and a third suppressed near-end signal outputting unit for outputting a third suppressed near-end signal by subtracting said echo component signal detected by said echo component detecting unit from either said first near-end signal converted by said first near-end voice converting unit or said second near-end signal converted by said second near-end voice converting unit.

12. A voice communication apparatus as set forth in claim 6, in which
said echo component detecting unit includes a real near-end voice estimating section for estimating, as a real near-end signal, a real near-end voice to be specified as a cross-component in each of said first and second near-end signals respectively converted by said first and second near-end voice converting units, a sixth near-end signal delay section for delaying either said first near-end signal converted by said first near-end voice converting unit or said second near-end signal converted by said second near-end voice converting unit with a delay time required to performing the estimation of said real near-end signal by said real near-end voice estimating section, and an echo component signal outputting section for outputting, as a first echo component signal, a signal indicative of the signal difference between said near-end signal delayed as a sixth delayed near-end signal by said sixth near-end signal delay section and said real near-end signal estimated by said real near-end voice estimating section, and in which
said third suppressed near-end signal outputting unit includes an echo component estimating section for estimating, as a second echo component signal, a signal to be specified as a component other than said real near-end voice in either said first near-end signal converted by said first near-end voice converting unit or said second near-end signal converted by said second near-end voice converting unit on the basis of said echo component signal outputted by said echo component signal outputting section, a seventh near-end signal delay section for delaying either said first near-end signal converted by said first near-end voice converting unit or said second near-end signal converted by said second near-end voice converting unit with a delay time required to performing the estimation of said echo component signal by said echo component estimating section, and a third outputting section for outputting a third suppressed near-end signal by subtracting said second echo component signal estimated by said echo component estimating section from said near-end signal delayed as a seventh delayed near-end signal by said seventh near-end signal delay section.

13. A voice communication apparatus as set forth in claim 6, in which
said real near-end voice estimating section has a first adaptive filter for executing the adaptive signal processing to perform the least absolute deviation estimation of a signal outputted by said echo component signal outputting section to either said first near-end signal converted by said first near-end voice converting unit or said second near-end signal converted by said second near-end voice converting unit, in which
said echo component estimating section has a second adaptive filter for executing the adaptive signal processing to perform the least absolute deviation estimation of a signal outputted by said third outputting section to said echo component signal outputted by said echo component signal outputting section, and in which
said echo suppressing means includes a current value detecting unit for detecting a current parameter value indicative of a current relative location of either said first near-end voice converting unit or said second near-end voice converting unit with respect to said far-end signal converting unit, a first initial value determining unit for determining, as a parameter of said adaptive signal processing, initial filter coefficients of said first adaptive filter in response to said current parameter value detected by said current value detecting unit, and a second initial value determining unit for determining, as a parameter of said adaptive signal processing, initial filter coefficients of said second adaptive filter in response to said current parameter value detected by said current value detecting unit.

14. A voice communication apparatus as set forth in claim 13, in which
said echo suppressing means includes an adaptive controlling unit for issuing an instruction to said first adaptive filter to update said first filter coefficients when the judgment is made that the near-end signal predetermined as one of said first and second near-end signals exceeds in amplitude said far-end signal, and issuing an instruction to said second adaptive filter to update said second filter coefficients when the judgment is made that said far-end signal exceeds in amplitude one of said first and second near-end signals.
